(19) United States
(12) Patent Application Publication
(10) Pub. No.: US 2023/0234397 A1
(43) Pub. Date: Jul. 27, 2023

(54) VEHICLE SUSPENSION SYSTEM WITH ACTIVE ADJUSTMENT OF WHEEL CASTER ANGLE AND RIDE HEIGHT

(71) Applicant: Winthrop Dada, Highlands Ranch, CO (US)

(72) Inventor: Winthrop Dada, Highlands Ranch, CO (US)

(21) Appl. No.: 18/158,949

(22) Filed: Feb. 22, 2023

Related U.S. Application Data
(60) Provisional application No. 63/302,235, filed on Jan. 24, 2022.

(51) Int. Cl. B60B 33/04; B62D 17/00

(52) U.S. Cl. CPC B60B 33/045; B62D 17/00

(57) ABSTRACT

A suspension system for a vehicle includes a wheel carriage assembly, a gear box, and steering and caster subsystems. The wheel carriage assembly and the steering and caster subsystems are pivotable with respect to one another via the gear box. The gear box pivotably couples the steering and caster subsystems to the wheel carriage assembly by rotatable arms such that translational motion applied by actuators and/or motors is transferred between the steering and caster subsystems and the wheel carriage assembly via the gear box. In addition, the wheel carriage assembly and the gear box are pivotable with respect to a chassis of the vehicle via the steering and caster subsystems via actuators and motors. Sensors are provided throughout the suspension system to provide input to a controller that outputs instructions to the actuators and/or motors, allowing the suspension system to actively adjust the pitch and roll of the vehicle.

### REFERENCE TO RELATED APPLICATIONS

This U.S. Non-Provisional Patent Application claims the benefit of priority from U.S. Provisional Patent Application Ser. No. 63/302,235, filed Jan. 24, 2022, the entire disclosure of which is hereby incorporated by reference.

### FIELD

Embodiments of the present disclosure relate to vehicle suspension systems. More specifically, various embodiments of the present disclosure relate to suspension systems with the ability to adjust and set the caster angle while driving and wheels having individually adjustable ride height.

### BACKGROUND

Four-wheeled vehicle suspension systems traditionally respond to turns by shifting the vehicle weight to the tires on the outside of the turn and to the tires in front when braking and to the tires in the rear when accelerating. This uneven distribution of loads results in reduced grip, uneven tire wear and wasted energy spent braking and re-accelerating for turns. However, by shifting the weight of the chassis and payload away from the tires bearing the natural G-Force loads of any given turn, stop or launch the mechanical grip provided by the tires can be maximized under all circumstances. The system described herein actively alters the pitch and roll of the chassis such that surge and sway forces acting upon the occupants and payload are largely eliminated. The remaining heave forces are used to press the tires onto whatever surface is available to provide maximum traction. Doing so simultaneously optimizes traction (and therefore safety), greatly reduces the possibility of roll-overs, reduces friction and boosts efficiency while the lack of motion transfer to occupants and payload significantly improves rider comfort and payload integrity.

### SUMMARY

Accordingly, there is a long-felt but unmet need for a vehicle suspension system with active adjustment of wheel caster angle and ride height. The suspension systems of the present disclosure shift the weight of the vehicle to allow all tires to provide the maximum frictional force and radial acceleration, by raising and lowering the suspension of each wheel assembly individually, thereby pitching and rolling the chassis away from the natural G-Forces acted upon the vehicle when accelerating, braking, or turning. The suspension systems of the present disclosure should be capable of actively adjusting the caster angle to allow the steering and suspension to compensate for active pitch changes on the chassis and vehicle speed, thereby simultaneously optimizing vehicle stability and reducing steering effort and wasted energy spent turning the wheels.

In embodiments of the present disclosure, the suspension systems are integrated into a polymetric auto-leveling systems (PALS) configured to operate with a robotic transportation platform (RTP). The PALS-RTP system is able to use lateral and longitudinal weight transfer to improve mechanical grip, and bring vehicle dynamic control benefits on any track or terrain. The PALS-RTP system remedies a host of the shortcomings of legacy suspension designs, such as a vast reduction in the uneven tire loading and longitudinal/lateral weight transfer of legacy vehicle suspension designs, as well as elimination of bump-steer and inconsistent roll center and instant center locations. The PALS-RTP system provides a suspension with zero bump-steer and full control of camber (via ride height), caster, and steering angles, by operating linearly and not on an arc. Exhibiting zero propensity for bump steer, the suspension systems of the present disclosure within the PALS-RTP system separate horizontal steering from vertical wheel motions, and features an infinite instant-center with a stable roll-center located at the track centerline and ground level.

The PALS-RTP system allows for chassis roll and pitch angles across 36 inches, or greater than 90 centimeters (cm), of fully independent wheel travel that negates inertial surge and sway forces. The operation of the PALS-RTP system creates performance gains across the dynamic spectrum, including shortened stopping distances and improved emergency handling along with an end to uneven tire-wear, as well as additional comfort and safety to occupants and/or items on a vehicle and/or within a vehicle cabin.

Additional embodiments of the present disclosure are directed to integrating the suspension systems into a modular intelligently networked inductive roadway track or system (MINI-RTS).

The suspension systems of the present disclosure are usable with nearly any wheeled device, including a small rover vehicle, a utility task vehicle (UTV), a passenger car, a large semi-autonomous transport freight wagon and recreational vehicle, and the like. Similarly, personal use vehicles such as a wheelchair or bicycle may benefit from the suspension system. In addition, the suspension system may be applied to an aircraft to reduce the bump-shock during landing procedures. The wheels may be interchanged or replaced with tracks for increased traction over land. The wheels may be interchanged or replaced with pontoons, fins, skis, or the like to allow for the use of the suspension system in a water, snow, or sand environment.

In one non-limiting example, a PALS-RTP system with four wheels includes 2 modular polymetric electric driveline suspension (M-PEDS) subchassis units, with each M-PEDS including two sets of components or subsystems of components, where each set of components or subsystems of components forms a suspension system of the present disclosure. It is noted that any M-PEDS unit may couple to a front (or nose) and rear (or tail) of a chassis, as the M-PEDS unit may differ only in software control but otherwise be fabricated identically (or based on a mirror symmetry). In some embodiments, the PALS-RTP system includes a host structural battery-bay main chassis, allowing for the swapping of battery systems from various suppliers and/or manufacturers. In additional embodiments, the PALS-RTP system includes a central computer that receives data from sensors (e.g., position sensors, internal measurement units, and the like) to compare against user inputs when calculating desired (e.g., pre-selected, ideal, optimized, and the like) settings for each wheel on the orders of sub-millisecond timing.

As described in detail, the suspension systems of the present disclosure include one or more of the following components or subsystems of components. For example, the suspension systems of the present disclosure may include a long-travel auto-leveling suspension (LoTALS) system including a wheel carriage assembly (WCA) with a proportional active drive system (PADS) motor mount, one or more outer geared lift arms (OGLA), one or more inner lift arms (ILA), a cross-link gear box (CLGB), and/or a geared/spring bell crank (GSBC). The suspension systems of the present disclosure may additionally or alternatively include a proportional all-wheel steering system (PAWS) fork assembly, which may include an articulated suspension travel rebound assist limiter (ASTRAL). The suspension systems of the present disclosure may additionally or alternatively include a polymetric active caster system (PACS) subframe. The suspension systems of the present disclosure may additionally or alternatively include a digital/analog navigation control interface (DANCI) system. It is noted that the subsystems may be separate subsystems that engage with and interact together. In addition, it is noted that the subsystems may share one or more components.

In embodiments, suspension systems are provided that actively adjust at least one or both of wheel caster, camber (via ride height), and steering angles independently of each wheel. As used herein, the term “active” or “actively” refers to purposeful adjustment of an element in response to a change in operating conditions, such as a motor being used to raise or lower a component, as opposed to reacting to a change in operating conditions, such as a spring being compressed by an increased load.

As used herein, the term “caster angle” refers to the angle between a steering axis and the vertical axis of the vehicle, as measured along the longitudinal axis of the vehicle, with positive caster having the bottom of the steering axis line in front of a tire contact patch, with an upper pivot point behind a lower pivot point (e.g., a backward slope pointed toward the back of the vehicle) and negative caster having the bottom of the steering axis line behind a tire contact patch, with the upper pivot point in front of the lower pivot point (e.g., a forward slope pointed toward the front of the vehicle). It is noted increasing positive caster may increase steering effort necessary to turn a wheel, improve cornering by increasing tire lean during a turn, and assist the tire in returning to an upright position when coming out of a turn. Increased positive caster also stabilizes a wheel at speed and helping keep a vehicle travelling in a straight line.

As used herein, the term “ride height” refers to a distance between a base of a wheel (or ground surface) and the lowest point on a vehicle (e.g., a point on an axle, exhaust system, transmission, engine, undercarriage or chassis, body panel, body trim (e.g., air dam, side skirts, or the like), bumper, or other component on a vehicle which is closest in vertical height to the base of the wheel or ground surface). While various embodiments of the present disclosure are contemplated for use with and are well suited for provision within electric vehicles, no limitation with respect to the intended use or application of systems of the present disclosure are provided herewith. For example, systems of the present disclosure are contemplated for use within various four-wheeled vehicles, two and three wheeled vehicles, and various other wheeled vehicles regardless of the vehicle's power train, seating arrangement, wheel arrangement, etc. In this regard, the present disclosure is not to be understood as limited to vehicles such as skateboards or automobiles, but instead may be applied to any vehicle which may benefit or be improved by active adjustment of wheel caster angle and ride height without departing from the scope of the present disclosure.

In various embodiments, the suspension systems of the present disclosure provide a separate wheel assembly (e.g., the LoTALS) for each wheel. Each wheel assembly (LoTALS) comprises an active height adjustable (PAWS) fork assembly that can raise and lower with respect to a wheel carriage assembly (or WCA) on which the wheel is mounted. The fork assembly (PAWS) is connected to the vehicle such that it travels vertically with the vehicle while the wheel of the wheel carriage assembly remains generally stationary on the driving surface. The fork assembly (PAWS) and wheel carriage assembly (WCA) are pivotally linked to a cross-link gearbox (or CLGB) coupled to and/or having a plurality of arms (e.g., a combination of the one or more OGLA and the ILA) connecting the fork assembly (PAWS) and the wheel carriage assembly (WCA) to the gearbox (CLGB). A subset of the arms is mounted on an upper axle (e.g., OGLA-T) within the gearbox (CGLB) and attached to the fork assembly (PAWS), a second subset of the arms are mounted on a lower axle (e.g., OGLA-B) within the gearbox (CGLB) and are attached to the wheel carriage assembly (WCA). The meshed gears are provided on the axles such that the rotation of the upper axle causes opposite rotation in the lower axle thereby keeping the upper set of arms (OGLA-T, attached to the fork) in-phase with the lower set of arms (OGLA-B, attached to the wheel carriage assembly (WCA)). In some embodiments, the gears and at least portions of the axles are located in a sealed gear box. In some embodiments, the center point of the gears are on the same plane as the other pivot points on the cross-link gearbox (CLGB) and in others they are wider or narrower to allow for better packaging and nesting of the suspension.

A motor or other actuator on the fork assembly (PAWS) pushes the arms triangulating the fork assembly (PAWS) and gearbox (CLGB) in a backwards and downwards fashion. These arms are attached to the geared axle that is in communication with the upper geared axle of the gearbox, such that any rotation of the upper arms (OGLA-T) causes reverse rotation in the lower arms (OGLA-B). Specifically, when the upper arms (OGLA-T) move to raise the fork assembly (PAWS), the lower arms (OGLA-B) move to raise the wheel carriage assembly (WCA) an equal amount with respect to the cross-link gearbox (CLGB). This allows the suspension system to raise and lower as desired in a linear fashion rather than an arc as seen in prior suspension designs.

The wheel assembly (LoTALS) allows the suspension system to traverse large vertical gaps in the terrain without rolling the vehicle, as the wheel height is able to vary without having to account for the steering tie rod or other components. In some embodiments, the wheel assembly (LoTALS) can move approximately 36 inches in 0.25 seconds. As the suspension system actively adjusts to counter obstacles and undulations in the terrain, the suspension can provide an ideal ride height at each corner such that the chassis angle negates whatever surge and sway forces may be acting on the payload and passengers. This results in optimal ride comfort and minimal motion transfer for occupants and payloads. Traditional vehicles rely on springs and dampers to provide ride comfort, which provide a set response to any change in the environment. Actively controlling ride height at each wheel allows the suspension systems described herein to react to the changing physical loads encountered by a vehicle as it navigates the environment in which it operates, thereby increasing the amount of traversable terrain.

In embodiments, the suspension systems of the present disclosure include a spring damper. In additional embodiments, the spring damper may be replaced with an electromagnetic linear actuator that could act as both a spring/damper and an energy recovery unit. The energy recovery unit generates electricity that is used for powering the lift motor or wheel motor.

Another aspect of the invention is a suspension subframe (PACS) that is operable to actively adjust the caster angle of the wheel. In some embodiments, the subframe (PACS) consists of two separate pivotable frame members positioned on opposite sides of the chassis, in others they are linked together from side-to-side. In some embodiments, the frame members are rotatably connected to the chassis by an axle or other rotatable member. Subframes (PACS) are located on opposite ends of the vehicle, the front end and the rear end as called for by an individual design either cross-linked from side to side or each wheel independently. The subframe (PACS) members are operable to pivot towards the front and rear end of the vehicle about a pivot axis which in turn alters the caster angle of the wheel to account for changes in vehicle speed, chassis pitch angle and the grade of the terrain.

At least one linear actuator is mounted on the chassis and can control the position of the subframe (PACS) member with respect to the chassis. The linear actuators may be positioned in front of the front frame member and behind the rear frame member. Alternatively, the linear actuator may be located centrally towards the center of the chassis. Alternatively still, the linear actuator may be positioned below a pivot point of the subframe (PACS), inside the frame and below the floor in the nose and/or the tail of the vehicle (e.g., FIGS. 11 and 12). It is noted this alternative configuration may require suspension subframes (PACS) with arms extending below the pivot point they alter caster around. In addition, it is noted this alternative configuration may result in more efficient packaging of components of the suspension system, which may free up room in the front and/or the back of the vehicle while lowering the center of gravity of the vehicle. In at least some of these embodiments there can be one linear actuator having two extendible arms, each connecting to the subframe (PACS).

The arm of each linear actuator is pivotally connected to a frame member such that the linear actuator pivots the frame member when it is extended and retracted. In some embodiments, the linear actuator is pivotally connected to both the chassis and the frame member. The frame members are attached to the chassis by an axle or other pivotable member. Thus, the linear actuator controls the position of the wheels with respect to the vehicle, thereby adjusting the caster angle. This allows the steering to account for the continuous changes in pitch-angle as created by the suspension system as described above. Ideal caster angle also varies with vehicle speed, the faster the vehicle the more positive caster desired and vice versa. The active caster system described herein allows the chassis to calculate and set the ideal caster angle with respect to the angle of chassis pitch and vehicle speed and the grade of the terrain at any given moment.

By actively pitching and rolling the chassis the system described herein seeks to equally load the wheels at all times to extract the maximum mechanical grip available irrespective of whether the vehicle is starting, turning or stopping. For example, during acceleration, the weight of the vehicle is naturally shifted towards the rear wheels. By actively pitching the chassis towards the front of the vehicle, the front wheels are positioned to take more weight than they would thereby utilizing far more of the available mechanical grip for acceleration. Conversely, when braking naturally the weight of the vehicle is shifted towards the front of the vehicle. By actively pitching the chassis backwards, the rear wheels bear more load and therefore are able to provide increased braking power.

The system described herein uses lift motors and linear actuators controlled by a central computer. The computer tells controllers to position the lift motor and the linear actuator such that the wheel is in the optimal ride height position and caster angle. The controller uses readings from sensors positioned about the vehicle to calculate the desired angle for the arms of the cross-link gear box (CLGB) and the amount of extension or retraction of the linear actuator to adjust caster angle. This allows the vehicle to both roll and pitch the chassis by actively adjusting the ride height of each wheel while also adjusting the caster angle. In doing so the system seeks optimal efficiency at all times with less caster angle (or a more negative caster) for less steering effort when moving slowly yet also enhancing stability by increasing positive caster at speed.

The suspension and chassis system seeks to optimize efficiency, maximize grip and to greatly increase rider comfort and payload integrity. For example, during a turn the lift motor can raise the suspension system of the outer wheels while lowering the suspension system of the inside wheels. By raising the outer suspension systems, the weight of the vehicle is shifted towards the inside wheels. Due to the weight of the vehicle being shifted to the inside tires, the frictional force on the inside tires is increased. Traditional suspension systems shift the weight of the vehicle to the outer tires, which increases the load on the outside tires but reduces the frictional force provided by the inside tires. By shifting the weight onto the inside tires, the frictional forces are more balanced and allow for increased frictional force between the tires and the ground, which increases the stability of the vehicle during turns. This also increases the maximum radial acceleration that the vehicle is able to sustain while maintaining control, thus allowing for much faster cornering and turns. When accelerating or braking, the caster angle can be adjusted such that the tires are moved towards the rear or front of the vehicle to provide additional frictional force, increasing steering grip and reducing slippage if moved toward the front of the vehicle and increasing braking grip if moved toward the rear of the vehicle. The active caster system (PACS) can be used alternatively to shorten the vehicle wheelbase for shorter turning radii or increased reach over obstacles (e.g., breakover angle), or lengthen the vehicle to provide additional stability at speed. This system can also be used to actively increase the approach and departure angles of the front and rear suspension components. The suspension and chassis system described herein will always seek neutral surge and sway G-forces by constantly adjusting ride height at each corner thereby altering the chassis heading angle depending on feedback from an array of sensors.

In some embodiments, the vehicle is controlled by a yoke having toggles (e.g., levers, buttons, switches, and the like) that operate as hand-brakes attached. The yoke is in electronic communication with the individual motors of the wheels such that pushing in the yoke causes deceleration of the motors and pulling out the yoke causes acceleration of the wheel motors. When braking is required, the toggles are used to activate the brakes and actively slow the vehicle. The user is able to steer by rotating the yoke similarly to a steering wheel. This embodiment allows users to operate the vehicle without the need to use foot pedals. Thus, disabled users, particularly those who are paraplegic or are otherwise unable to operate the gas and brake pedals of traditional automobiles, can fully operate the vehicle. This embodiment provides enhanced comfort to operators generally, regardless of ableness. It is noted, however, that traditional gas and brake pedals may be utilized in addition to or instead of the actuation of the yoke and/or the toggles on the yoke.

In some embodiments, the linear actuators may be supplemented by or replaced by any known gear, power transmission belt, or chain drive known in the art. In one non-limiting example, the linear actuators may be supplemented with or replaced by a primary ring or spur gear on the axle of the subframe. Caster angle may be adjusted by turning a secondary spur gear with an electric motor, where the secondary spur gear meshes with the primary ring or spur gear. In another non-limiting example, the linear actuators may be supplemented with or replaced by a worm-gear and worm-wheel assembly. It is noted this may result in more efficient packaging of components of the suspension system.

In some embodiments, the suspension system uses a motorcycle style tire. A motorcycle tire includes a rounded tread and sidewall, as compared to an automobile tire with a more defined transition between tire tread and more stiff sidewall. The rounded surface of the motorcycle tire allows the tire to lean into turns rather than remaining flat. In some embodiments, the vehicle is able to lean into turns by up to 45 degrees. Leaning into turns assists the system in shifting the weight to the inside tires, increasing the traction while turning.

In some embodiments, the suspension system uses a UTV tire. A UTV tire is more pliant as compared to an automobile tire, such that its slippage and/or deforming when the vehicle is turning, accelerating, and/or braking may need to be monitored more closely than an automotive tire. Adjusting for caster angle and/or fork positioning may remove or adjust forces applied to the UTV tires, increasing stability and/or control of the vehicle.

In some embodiments, the suspension system uses robust bearings on the inside only thereby dividing the suspension in half, thus allowing for sideways swapping of tires and/or wheels with tires and rims. In some embodiments, the suspension system uses two horizontally opposed gearboxes at each wheel rather than the cross-link gearbox (CLGB), thus allowing for “nesting” of the arms such that the gear boxes are moved closer to the wheel without sacrificing arm-length and therefore wheel-travel. In some embodiments, the suspension system uses two opposed suspension height lift mechanisms rather than one at each wheel.

In some embodiments, independent half axles may be positioned on both sides of the wheel carriage assembly (WCA), each with at least one set of bearing apiece. In some embodiments, a set of long bolts may span the distance between the half axles. In some embodiments, a wheel that corresponds with the width between the half axles may insert between the half axles and be secured by fasteners (e.g., bolts, and the like) that span the distance between the half axles, thereby securing the wheel. It is noted utilizing components such as half axles allows for rapid swapping of wheels and tires via use of the LoTALS system.

In one aspect of the present disclosure, a suspension system for a vehicle comprises a wheel carriage assembly including a wheel carriage and a wheel. The suspension system comprises a steering subsystem including a fork assembly, the steering subsystem operable to rotate the wheel between a first steering direction and a second steering direction. The suspension system comprises a caster subsystem coupled to the steering subsystem, the caster subsystem operable to rotate the fork assembly between a first caster angle and a second caster angle, wherein the caster subsystem is coupled to the steering subsystem. The suspension system comprises a linkage assembly coupled to the steering subsystem, the linkage assembly operable to translate the wheel between a first wheel height and a second wheel height relative to the fork assembly of the steering subsystem. The suspension system comprises a gear box, wherein the steering subsystem, the caster subsystem, and the linkage assembly are coupled to the wheel carriage assembly via the gear box.

In some aspects, the suspension system comprises at least one arm coupled to the gear box and the wheel carriage of the wheel carriage assembly. The suspension system comprises at least a second arm coupled to the gear box and the fork assembly of the steering subsystem, the at least a second arm including a pivot frame configured to couple to the linkage assembly. The translational motion between the first wheel height and the second wheel height is transferred between the linkage assembly and the wheel carriage assembly via the at least one arm and the at least a second arm.

In some aspects, the gear box comprises a first spur gear in communication with the at least one arm coupled to the gear box and the carriage frame of the wheel carriage assembly. The gear box comprises a second spur gear in communication with the at least a second arm coupled to the gear box and the fork assembly of the steering subsystem. The first and second spur gears are intermeshed such rotation of the first spur gear in a first rotational direction causes the second spur gear to rotate in a second rotational direction to transfer the translational motion between the first wheel height and the second wheel height between the linkage assembly and the wheel carriage assembly.

In some aspects, the linkage assembly comprises a damper. The linkage assembly comprises a linkage coupled to the damper. The linkage assembly comprises a lift motor and a worm gear assembly operable to actuate the linkage to compress or decompress the damper and cause the wheel to translate between the first wheel height and the second wheel height relative to the fork assembly of the steering subsystem, wherein the translation between the first wheel height and the second wheel height is transferred to the wheel via the gear box.

In some aspects, the damper is coupled to the gear box via at least one arm. In some aspects, the wheel carriage assembly includes a motor operable to drive the wheel.

In some aspects, the steering subsystem comprises a head tube coupled to and operable to rotate about a steer tube of the fork assembly. In some aspects, the steering subsystem comprises a steering motor and worm gear assembly operable to rotate the steer tube of the fork assembly between the first steering direction and the second steering direction, wherein the rotation between the first steering direction and the second steering direction is transferred to the wheel via the gear box.

In some aspects, the caster subsystem comprises a subframe coupled to the head tube of the steering subsystem. The caster subsystem comprises a caster motor and worm gear assembly operable to rotate the subframe between the first caster angle and the second caster angle, wherein the rotation between the first caster angle and the second caster angle is transferred to the wheel via the steering subsystem and the gear box.

In some aspects, at least one motor of the suspension system is powered by a battery pack installed on the chassis of the vehicle.

In another aspect of the present disclosure, a vehicle comprises a chassis. The vehicle comprises a plurality of suspension systems. Each suspension system of the plurality of suspension systems comprises a wheel carriage assembly including a wheel carriage and a wheel. Each suspension system of the plurality of suspension systems comprises a steering subsystem including a fork assembly, the steering subsystem operable to rotate the wheel between a first steering direction and a second steering direction. Each suspension system of the plurality of suspension systems comprises a caster subsystem coupled to the steering subsystem, the caster subsystem operable to rotate the fork assembly between a first caster angle and a second caster angle, wherein the caster subsystem is coupled to the steering subsystem. Each suspension system of the plurality of suspension systems comprises a linkage assembly coupled to the steering subsystem, the linkage assembly operable to translate the wheel between a first wheel height and a second wheel height relative to the fork assembly of the steering subsystem. Each suspension system of the plurality of suspension systems comprises a gear box, wherein the steering subsystem, the caster subsystem, and the linkage assembly are coupled to the wheel carriage assembly via the gear box. At least one suspension system of the plurality of suspension systems are independently adjustable with respect to at least one of steering direction, wheel caster angle, and wheel height relative to the other suspension systems of the plurality of suspension systems.

In some aspects, a first wheel of a first suspension system of the plurality of suspension system is rotatable between a first steering direction and a second steering direction while the respective steering direction of other wheels of the other suspension systems of the plurality of suspension systems remains substantially constant.

In some aspects, a first wheel of a first suspension system of the plurality of suspension system is rotatable between a first caster angle and a second caster angle while the respective caster angle of other wheels of the other suspension systems of the plurality of suspension systems remains substantially constant.

In some aspects, a first wheel of a first suspension system of the plurality of suspension system is translatable between a first wheel height and a second wheel height while the respective wheel heights of other wheels of the other suspension systems of the plurality of suspension systems remains substantially constant.

In some aspects, at least one suspension system of the plurality of suspension systems is swappable on the chassis as a complete unit.

In some aspects, the vehicle comprises at least one battery pack installed on the chassis of the vehicle and operable to power one or more motors of each of the plurality of suspension systems. In some aspects, the at least one battery pack is swappable on the chassis.

In some aspects, the vehicle comprises at least one sensor operable to collect data for at least one suspension system of the plurality of suspension systems. The vehicle comprises at least one controller operable to receive the data from the at least one sensor, the at least one controller operable to determine one or more adjustments to the at least one suspension system of the plurality of suspension systems based on the received data, the at least one controller operable to transmit a control signal to at least one motor on the at least one suspension system of the plurality of suspension systems based on the determined adjustment. The control signal transmitted to at least one motor on the at least one suspension system of the plurality of suspension systems causes an adjustment in at least one of steering direction, caster angle, and ride height of the wheel of the at least one suspension system of the plurality of suspension systems.

In another aspect of the present disclosure, a method for controlling a vehicle may include, but is not limited to, collecting data via at least one sensor on a suspension system. The suspension system comprises a wheel carriage assembly including a wheel carriage and a wheel. The suspension system comprises a steering subsystem including a fork assembly, the steering subsystem operable to rotate the wheel between a first steering direction and a second steering direction. The suspension system comprises a caster subsystem coupled to the steering subsystem, the caster subsystem operable to rotate the fork assembly between a first caster angle and a second caster angle, wherein the caster subsystem is coupled to the steering subsystem. The suspension system comprises a linkage assembly coupled to the steering subsystem, the linkage assembly operable to translate the wheel between a first wheel height and a second wheel height relative to the fork assembly of the steering subsystem. The suspension system comprises a gear box, wherein the steering subsystem, the caster subsystem, and the linkage assembly are coupled to the wheel carriage assembly via the gear box. The method for controlling a vehicle may include, but is not limited to, receiving the data collected by the at least one sensor via at least one controller. The method for controlling a vehicle may include, but is not limited to, determining one or more adjustments to the suspension system based on the received data. The method for controlling a vehicle may include, but is not limited to, transmitting a control signal to the suspension system based on the determined adjustment. The control signal transmitted to the suspension system causes an adjustment in at least one of steering direction, caster angle, and ride height of the wheel of the suspension system.

In some aspects, the control signal is transmitted to at least one motor on the suspension system.

In some aspects, the method may include, but is not limited to, receiving an input from a user control. The method may include, but is not limited to, determining one or more adjustments to the suspension system based on the received input. The method may include, but is not limited to, transmitting a control signal to the suspension system based on the determined adjustment. The control signal transmitted to the suspension system causes an adjustment in at least one of steering direction, caster angle, and ride height of the wheel of the suspension system.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the present disclosure is intended by either the inclusion or non- inclusion of elements, components, etc. in this Summary. Additional aspects of the present disclosure will become more clear from the Detailed Description, particularly when taken together with the drawings.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In addition, the materials, methods, and examples are illustrative only and are not intended to be necessarily limiting.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

Unless otherwise indicated, all numbers expressing quantities, dimensions, conditions, ratios, ranges, and so forth used in the specification and claims are to be understood as being modified in all instances by the term “about” or “approximately”. Accordingly, unless otherwise indicated, all numbers expressing quantities, dimensions, conditions, ratios, ranges, and so forth used in the specification and claims may be increased or decreased by approximately 5% to achieve satisfactory results. Additionally, where the meaning of the terms “about” or “approximately” as used herein would not otherwise be apparent to one of ordinary skill in the art, the terms “about” and “approximately” should be interpreted as meaning within plus or minus 5% of the stated value.

All ranges described herein may be reduced to any sub-range or portion of the range, or to any value within the range without deviating from the invention. For example, the range “5 to 55” includes, but is not limited to, the sub-ranges “5 to 20” as well as “17 to 54.”

The use of “including,” “comprising,” or “having” and variations thereof herein is meant to encompass the items listed thereafter and equivalents thereof as well as additional items. In addition, the transitional term “comprising” is synonymous with “including,” “containing,” or “characterized by,” is inclusive or open-ended and does not exclude additional, unrecited elements or method steps. Accordingly, the terms “including,” “comprising,” or “having” and variations thereof can be used interchangeably herein.

The transitional phrase “consisting of” excludes any element, step, or ingredient not specified in the claim, but does not exclude additional components or steps that are unrelated to the disclosure such as impurities ordinarily associated therewith.

The transitional phrase “consisting essentially of” limits the scope of a claim to the specified materials or steps and those that do not materially affect the basic and novel characteristic(s) of the claimed invention

The preceding is a simplified summary of the disclosure intended to provide an understanding of some aspects of the settler devices of this disclosure. This Summary is neither an extensive nor exhaustive overview of the invention and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below. As will be appreciated, other embodiments are possible using, alone or in combination, one or more of the features set forth above or described herein. For example, it is contemplated that various features and devices shown and/or described with respect to one embodiment may be combined with or substituted for features or devices of other embodiments regardless of whether or not such a combination or substitution is specifically shown or described herein. Additional aspects of the present invention will become more readily apparent from the Detailed Description, particularly when taken together with the drawings.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

### BRIEF DESCRIPTION OF THE DRAWINGS

The accompanying drawings, which are incorporated in and constitute a part of the specification, illustrate embodiments of the disclosed system and together with the general description of the disclosure given above and the detailed description of the drawings given below, serve to explain the principles of the disclosed system(s) and device(s). Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein. In the drawings:

FIG. 1 is a perspective view of a suspension system in extension, the suspension system including a long-travel auto-level suspension system (LoTALS), a polymetric all-wheel steering system (PAWS), and a polymetric active caster system (PACS), and, in accordance with one or more embodiments of the present disclosure;

FIG. 2 is a perspective view of the suspension system of FIG. 1 in compression, in accordance with one or more embodiments of the present disclosure;

FIG. 3 is a perspective view of the suspension system of FIG. 1 in transition between extension and compression, in accordance with one or more embodiments of the present disclosure;

FIG. 4 is a perspective view of the LoTALS of FIG. 3 without a wheel, in accordance with one or more embodiments of the present disclosure;

FIG. 5 is a perspective view of a cross-link gear box (CLGB) of the LoTALS of FIG. 4, in accordance with one or more embodiments of the present disclosure;

FIG. 6 is a first perspective view of the LoTALS of FIG. 4 without the CLGB, in accordance with one or more embodiments of the present disclosure;

FIG. 7 is a second perspective view of the LoTALS of FIG. 4 without the CLGB, in accordance with one or more embodiments of the present disclosure;

FIG. 8 is a perspective view of the PAWS of FIG. 1, in accordance with one or more embodiments of the present disclosure;

FIG. 9 is a perspective view of the PAWS and PACS of FIG. 1, in accordance with one or more embodiments of the present disclosure;

FIG. 10 is a perspective view of the PACS of FIG. 9, in accordance with one or more embodiments of the present disclosure;

FIG. 11 is a first perspective view of a vehicle including four suspension systems of FIG. 1 paired into two modular polymetric electric driveline suspension (M-PEDS) units, in accordance with one or more embodiments of the present disclosure; and

FIG. 12 is a second perspective view of the vehicle of FIG. 10, in accordance with one or more embodiments of the present disclosure.

The drawings are not necessarily (but may be) to scale. In certain instances, details that are not necessary for an understanding of the disclosure or that render other details difficult to perceive may have been omitted. It should be understood, of course, that the disclosure is not necessarily limited to the embodiments illustrated herein. As will be appreciated, other embodiments are possible using, alone or in combination, one or more of the features set forth above or described below. For example, it is contemplated that various features and devices shown and/or described with respect to one embodiment may be combined with or substituted for features or devices of other embodiments regardless of whether or not such a combination or substitution is specifically shown or described herein.

### DETAILED DESCRIPTION

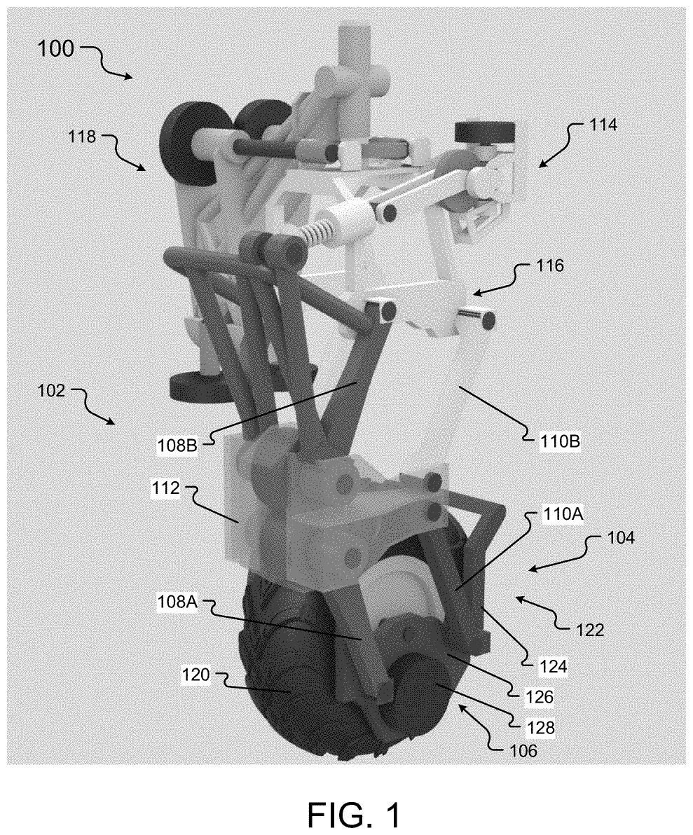

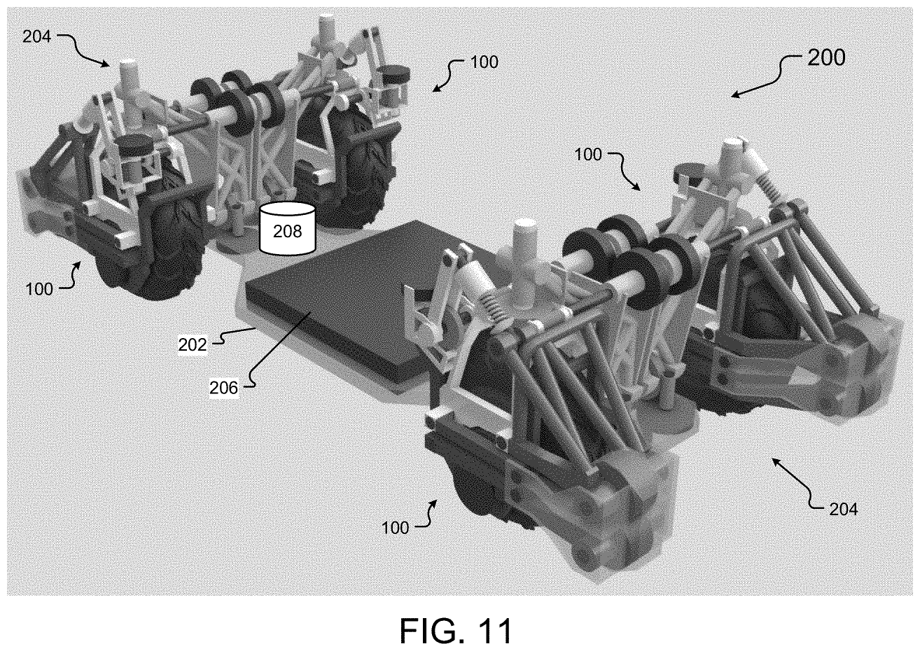

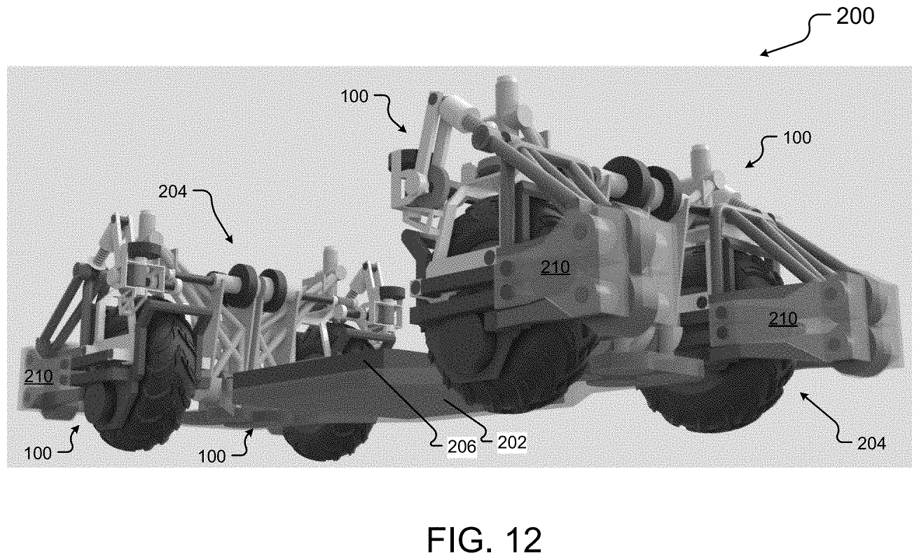

FIG. 1-12 generally illustrate a vehicle suspension system 100 according to embodiments of the present disclosure. Depicted embodiments provide systems with active adjustment of wheel caster and/or ride height, for example. It is noted that the vehicle suspension system in FIGS. 1-10 is for one wheel, and that FIGS. 11-12 illustrate a vehicle chassis including four vehicle suspension systems paired into two units, in accordance with one or more embodiments of the present disclosure. The suspension systems 100 of the present disclosure work together and/or in tandem to shift the weight of a vehicle to allow all tires to provide the maximum frictional force and radial acceleration, by raising and lowering the suspension at each suspension system 100 individually, thereby pitching and rolling the chassis away from the natural G-Forces acted upon the vehicle when accelerating, braking, or turning. The suspension systems 100 of the present disclosure should each be capable of actively adjusting the caster angle within the respective suspension system 100 to allow the steering and suspension to compensate for active pitch changes on the chassis and vehicle speed, thereby simultaneously optimizing vehicle stability and reducing steering effort and wasted energy spent turning the wheels.

As generally described throughout the present disclosure, the suspension system 100 includes one or more of the following components or subsystems of components. For example, the suspension systems of the present disclosure may include a long-travel auto-leveling suspension (LoTALS) system 102 including a wheel carriage assembly (WCA) 104 with a proportional active drive system (PADS) 106, one or more outer geared lift arms (OGLA) 108, one or more inner lift arms (ILA) 110, a cross-link gear box (CLGB) 112, and/or a geared/spring bell crank (GSBC) 114. The suspension systems 100 of the present disclosure may additionally or alternatively include a proportional all-wheel steering system (PAWS) 116, which may include an articulated suspension travel rebound assist limiter (ASTRAL). The suspension systems 100 of the present disclosure may additionally or alternatively include a polymetric active caster system (PACS) 118. The suspension systems of the present disclosure may additionally or alternatively include a digital/analog navigation control interface (DANCI). It is noted that the subsystems may be separate subsystems that engage with and interact together. In addition, it is noted that the subsystems may share one or more components between the various subsystems.

In embodiments, a translational motion is transferrable between the WCA 104 and the CSBC 114 via the CLGB 112 to adjust a wheel height between a first height and a second height. A first rotational motion about a first axis is transferrable between the WCA 104 and the PAWS 116 via the CLGB 112 to adjust a wheel direction between a first steering direction and a second steering direction. A second rotational motion about a second axis is transferrable between the WCA 104 and the PACS 118 via the PAWS 116 and the CLGB 112 to adjust a wheel caster between a first caster angle and a second caster angle.

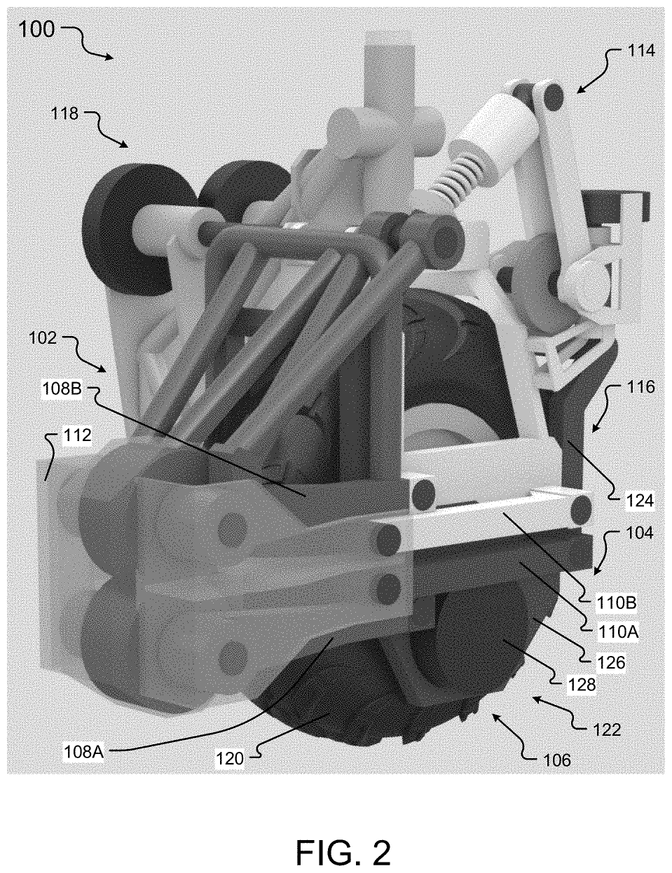

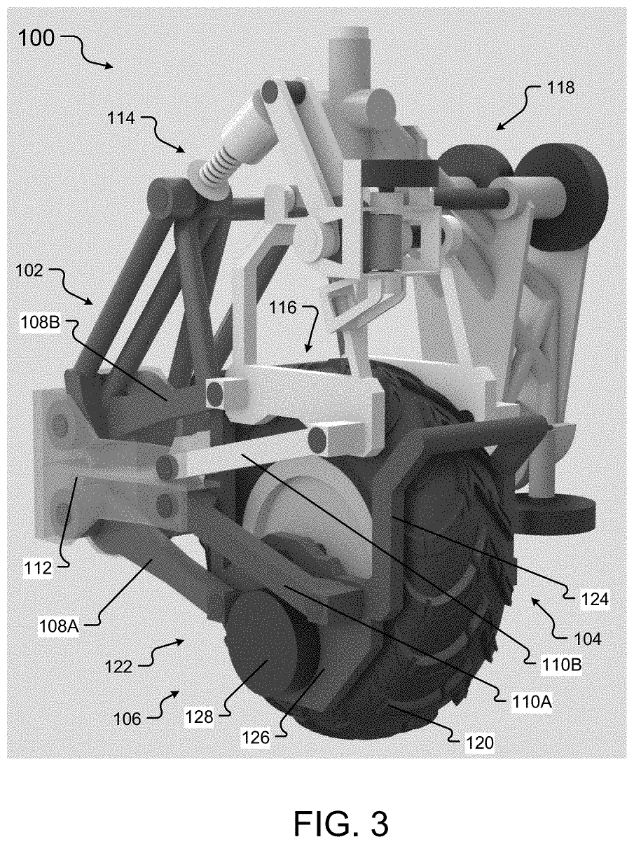

Referring now to FIGS. 1-3, the suspension system 100 is illustrated in an extension position (FIG. 1), in a compression position (FIG. 2), and in a transition state or position between the extension position and the compression position (FIG. 3). It is noted that the suspension system 100 should not be understood as being illustrated as at the maximum extension position and/or the minimum compression position, and that positions beyond those shown in FIGS. 1 and 2 may be achieved without departing from the scope of the present disclosure. In addition, it is noted that the suspension system 100 may have any number of transition states or positions between the extension position and the compression position, without departing from the scope of the present disclosure.

The WCA 104 includes a wheel 120 with tire and rim. For example, the tire may include, but is not limited to, an automobile tire, a motorcycle tire, a utility task vehicle (UTV) tire, or other tire known in the art. For example, toroidal tires like that of a motorcycle facilitate the rolling motion of the vehicle. In addition, the contoured sidewalls of toroidal tires enhance comfort and traction with reduced rolling resistance. This tire design allows the vehicle to lean into turns rather than remaining flat as traditional vehicles do. This also allows the vehicle to actively shift the weight of the vehicle such that the weight is distributed more evenly between the inner and outer wheels during the turn. In addition, off-road tires from a UTV provide maximum off-road traction. It is noted that the tire selected for use with the suspension system 100 may be dependent on the intended usage of the suspension system 100 (e.g., on which vehicle, in which environment, and the like). The WCA 104 may include an additional (or alternative) outer wheel 120.

It is noted the wheel 120 may be swappable based on the intended usage of the suspension system 100. For example, the LoTALS subsystem 102 may employ quick-change wheel-swap technology by employing a wheel very similar to those of many motorcycles. In addition, as described in detail herein the vehicle employing the suspension system 100 are able to “self-jack” as a condition of normal use, where one wheel 120 may be lifted with the suspension system 100 while the other wheels 120 stay on the ground (and the vehicle remains balanced). No additional jacking devices or components are necessary, which allows for an easier and more efficient changing of the wheel 120, with reduced effort from the user.

The WCA 104 includes a wheel carriage 122, into which the wheel 120 seats. The wheel carriage comprises a carriage frame 124. A lower sidewall 126 extends downwards from the sides of the frame 124. Each sidewall 126 has at least one aperture. For example, there may be at least two apertures on each sidewall 126. The apertures in the sidewall 126 provide a connection point for the cross members or arms of the OGLA 108A (e.g., OGLA-B 108A) and/or ILA 110A (ILA-B 110A), as described in detail herein. In addition to the aperture(s), the sidewalls 126 includes a wheel axle port in each sidewall 126 that holds a wheel axle. In additional embodiments, a plurality of apertures are formed in the wheel-carriage frame 124. For example, four apertures may be formed within the wheel carriage frame 124 in addition to the axle port.

In embodiments, the wheel carriage 122 includes a wheel carriage frame 124, an axle port in the frame configured to hold an axle for the tire 120 of the vehicle, and a drive motor 128 to rotate the wheel 120. In some embodiments, the drive motor 128 is a hub motor located concentrically within the wheel 120, and positioned on the wheel carriage frame 124 and configured to drive the single wheel 120 of the vehicle. In some embodiments, a drive motor 128 can be positioned on the WCA 104 and connected to the axle or wheel 120 by a drive train. In these embodiments, the drive motor 128 can be a pancake motor mounted on the wheel carriage 122 and directly attached to the axle or attached to the axle via a linkage or other drive train. The drive train can include chains, belts, gears, or other power transferring mechanisms that link the drive motor 128 to the axle of the wheel 120. In some embodiments, axial-flux electric motors may be used, which may include standard stage geartrains in communication with the axle of the wheel 120, and/or planetary gear trains positioned about the axle of the wheel 120. It is noted that there may be a gear increase or reduction between the wheel 120 and the drive motor 128. For example, a 4.3:1 gear reduction effected through a single-stage spur gear drivetrain may be implemented in the WCA 104. Where planetary gear trains are used, the overall PADS 106 may be more compact than where a single-stage spur gear is used.

As the suspension system 100 encounters surface undulations, the WCA 104 moves with the wheel 120 as part of a unified structure, resisting deflection and providing a stable mount for the PADS 106 motor(s) 128, gearbox(es), brake caliper(s), split-axles, and disc brakes (not shown). In some embodiments, split-axles may bolt integrally to the wheel 120 from either side of the WCA 104, allowing for dual motors 128 at each wheel 120 if desired. For example, the split-axles are separate axles, with one on either side of the wheel 120 at the WCA 104 with large lug-bolts that span the width of the wheel 120 between two flanges, forming a solid yet light wheel structure. This allows for quick-swapping of the wheels 120, whereby lug-bolts (e.g., 5) are removed and the self-jacking nature of the vehicle allows it to “lift a paw” for wheel swaps.

In embodiments, the wheel 120 is positioned in the middle of the wheel carriage 122 and the PAWS 116. However, in some embodiments, the wheel carriage 122 and the PAWS 116 are located on only one side of the wheel 120. In some embodiments, the wheel carriage 122, PAWS 116, and CLGB 112 are halved, such that only one side of the assembly is required. In non-limiting examples, the CLGB 112 includes or is coupled to only four arms, two upper arms 134, 136 and two lower arms 130, 132. Similarly, the wheel carriage 122 and the PAWS 116 may include only two apertures to connect the upper and lower arms 130, 132, 134, 136. In other non-limiting examples, the CLGB 112 may include or be coupled to eight arms, with an arm on each side of each pivot point. In some of these embodiments, the wheel carriage 122, the PAWS 116, and the CLGB 112 are located on the proximal side of the wheel 120 with respect to the vehicle. In some embodiments, the wheel carriage 122, the PAWS 116, and the CLGB 112 are located on the distal or outer side of the wheel 120.

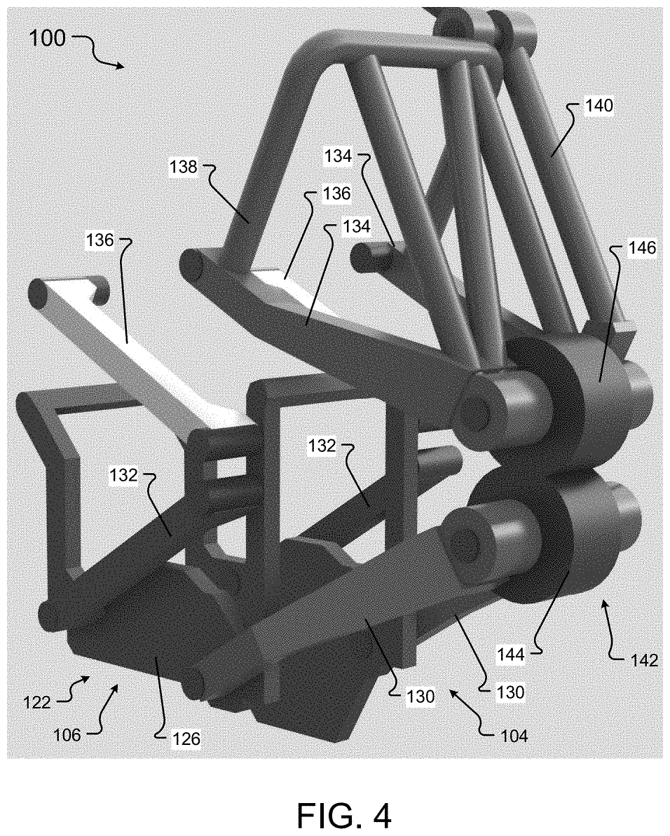

Referring now to FIGS. 4-6, the suspension system 100 is shown without the wheel 120, to focus on the OGLA 108, the ILA 110, and the CLGB 112.

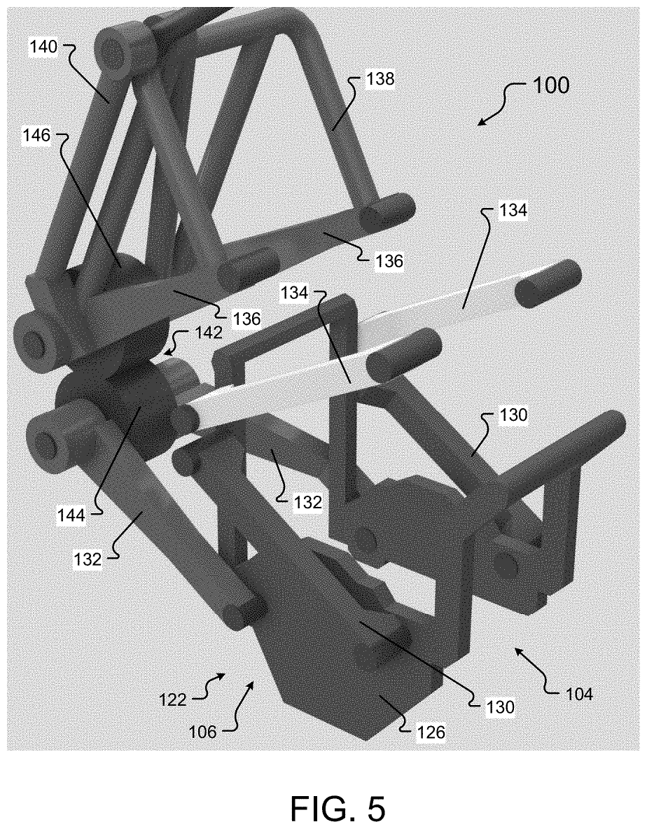

As illustrated in at least FIGS. 4-5, the WCA 104 is coupled to the CLGB 112 via the OGLA 108A and the ILA 110A. For example, the OGLA 108A includes arms 130 that flank the wheel carriage 122 at a first end of the wheel carriage 122. For instance, the arms 130 couple to apertures in the sidewalls 126. By way of another example, the ILA 110A includes a pair of cross members 132 that flank the wheel carriage 122 at a second opposite end of the wheel carriage 122. For instance, the arms 130 couple to additional apertures in the sidewalls 126. The arms 130, 132 are pivotally linked to the WCA 104 and the CLGB 112.

The PAWS 116 is coupled to the CLGB 112 via an OGLA 108B (e.g., OGLA-T 108B) and an ILA 110B (e.g., ILA-T 110B). For example, the OGLA 108B includes arms 134 that are located above the OGLA 108A at the first end of the wheel carriage 122. By way of another example, the ILA 110B includes a pair of cross members 136 that are located above the ILA 110A at the second opposite end of the wheel carriage 122. The arms 134, 136 are pivotally linked to the CLGB 112 and the PAWS 116.

In embodiments, the ILA arms 132, 136 maintain the geometry of the other suspension components. The ILA 110A, 110B resist suspension deflection with widened and reinforced pivot points, including sealed tapered roller bearings in lieu of bushings. The pivot points of the ILA arms 132, 136 stack neatly inside the wider pivot points of the OGLA arms 130, 134, enabling a very compact suspension with extremely long wheel travel.

It is noted the arms 130, 132, 134, 136 may be straight or may include one or more bends, without departing from the scope of the present disclosure. For example, bends may be necessary where the pivot points are within a single plane, to introduce compactness into the build of the suspension system 100. By way of another example, where the pivot points of at least one set of arms (e.g., 130, 134 of the OGLA 108) are offset or in a different plane than the pivot points of at least a second set of arms (e.g., 132, 136 of the ILA 110), the arms may be straight while still allowing for “nesting” of the arms 130, 132, 134, 136. In general, any combination of straight arms, and arms with one or more bends, may be combined within the suspension system 100, without departing from the scope of the present disclosure.

In embodiments, the OGLA arms 130, 134 engage with splined shafts coming out of the CLGB 112 (e.g., as opposed to tapered roller-bearings of the ILA 110A, 110B). The arms 134 may include or be coupled to a support frame 138. For example, the support frame 138 may directly couple together the arms 134 in addition to the indirectly coupling via the CLGB 112 and/or the fork assembly of the PAWS 116 (described in detail herein). It is noted the support frame 138 may be symmetric or substantially symmetric about the center line of the CLGB 112, or may alternatively be set to one side of the center line of the CLGB 112, without departing from the scope of the present disclosure.

In some embodiments, the arms 134 include or be coupled to a pivot frame 140 connected to a spring of the GSBC 114, as described in detail herein. For example, the pivot frame 140 may be separate from, coupled to, or integrated with the support frame 138.

In this regard, the CLGB 112 connects pivotally to the anterior ends of both the top and bottom sets of arms 130, 132, 134, 136 of the OGLA 108A, 108B and the ILA 110A, 110B respectively. The CLGB 112 serves to maintain proper articulation geometries, where the upper and lower sets of arms remain “in phase” via a gearset 142 with splined shafts connected to the anterior end of the arms 130, 134 of the OGLA 108A, 108B respectively. The CLGB 112 thus ensures linear wheel movement, and any arc motion of the upper arms 134, 136 negate any arc motion of the respective corresponding lower arms 130, 132.

The gearset 142 with a lower gear 144 and an upper gear 146. The lower gear 144 is in communication with the arms 130 of the OGLA 108A via a lower axle 148, and the upper gear 146 is in communication with the arm 134 of the OGLA 108B via an upper axle 150. The CLGB 112 causes the PAWS 116 and the WCA 104 to be rotationally locked, such that the rotation of the upper gear 146 causes opposite rotation in the lower gear 144, thereby keeping the upper set of arms 134 in-phase with the lower set of arms 130. In some embodiments, the center point of the gearset 142 is on the same plane as the other pivot points on the CLGB 112. However, it is noted the center point of the gearset 142 may be wider or narrower to allow for better packaging and nesting of the suspension system 100, without departing from the scope of the present disclosure.

It is noted that the lower gear 144 may be one or more gears with a corresponding upper gear 146 (e.g., one lower gear 144, one upper gear 146; two lower gears 144 each with a corresponding upper gear 146; and the like), without departing from the scope of the present disclosure. In addition, it is noted the gears 144, 146 may be any gears in the art including, but not limited to, spur gears. it is noted that the gearset 142 may include one or more intermediate gears between in communication with the gears 144, 146 to adjust gear ratio and forces transferred within the suspension system 100.

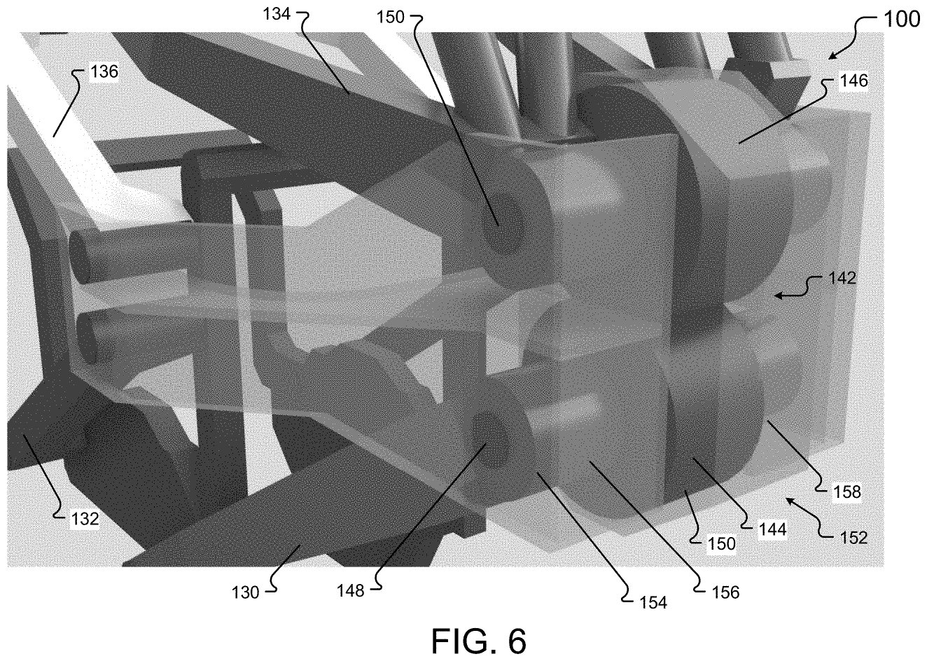

As illustrated in at least FIG. 6, the CLGB 112 includes a housing 152. For example, the housing 152 may be formed from one or more sidewalls, one or more end walls, one or more upper and/or lower surfaces, and/or a gear box for the gearset 142. In one non-limiting example, the CLBG 112 includes two side walls 154 and an end wall 156 coupled to the ends of the sidewall 154. By way of another example, the gearset 142 and at least portions of the first and second axles are located in a sealed gear box 158 of the housing 152. For instance, the sealed gear box 158 is coupled to the end wall 156. In some embodiments, the sealed gear box 158 houses the lower axle 148 and the upper axle 150, each axle having corresponding gears 144, 146 that engage one another to transfer motion of the PAWS 116 to the WCA 104, and vice versa.

Although embodiments of the present disclosure are directed to the OGLA 108 and the ILA 110 being separate from and coupled to the CLGB 112, it is noted that one or more arms of the OGLA 108 and/or ILA 110 may be considered part of the CLGB 112, without departing from the scope of the present disclosure. In one non-limiting example, the CLGB 112 may include a plurality of upper arms and lower arms attached to the sidewalls 154. For instance, the CLGB 112 may include at least four upper arms and at least four lower arms. The four upper arms include two front arms and two rear arms. In some embodiments, the front upper arms extend forwards and are bent upwards, and in some embodiments from the front upper arms extend forward and are straight. The rear upper arms extend forwards and form some or all of the support frame 138 extending upwards from the front and rear ends of the arms. For example, a first portion of the support frame 138 of the rear upper arms may extend towards an opposite portion of the support frame 138 of the opposing rear upper arm. In some embodiments, the support frames 138 of the rear upper arms meet at the center line of the CLGB 112. The at least four lower arms are comprised of at least two rear lower arms and at least two front lower arms. The lower arms extend forwards and downwards away from the gearset 142. The lower arms are pivotally attached to both the sidewalls 154 of the CLGB 112 and the wheel carriage 122. The rear upper arms and the rear lower arms are located on common axles, respectively. A set of spur gears is positioned on the common axle of the rear upper arms and the rear lower arms. The gears of the upper axle are engaged to the gears of the lower axle.

Although embodiments of the present disclosure are directed to a single CLGB 112, it is noted the suspension system 100 may include multiple gearsets 142 and/or multiple CLGB 112 positioned around the WCA 104, without departing from the scope of the present disclosure. In one non-limiting example, there are four gearsets 142 and/or CLGB 112 positioned on each corner of the wheel carriage 122, with each of the gearsets 142 and/or multiple CLGB 112 includes two spur gears that are connected to axles as described herein. Rather than containing a single gear box, the gearsets 142 and/or multiple CLGB 112 are located at the ends of the axles. This allows for a distribution of force across four different gearsets 142 and/or CLGB 112 instead of a concentration across only two geared axles 148, 150.

In the multiple gear box embodiment, arms may extend from each of the rear two gear boxes and additional arms may extend from each of the front two gear boxes. In each of the gear boxes, one arm is attached to the opposite end of the wheel carriage and one arm is attached to the opposite end of the fork assembly. A spring damper may be attached to the gear boxes at one end of the assembly. In addition, the spring damper is connected to the gear boxes positioned opposite a bell crank or linkage and a tie shaft.

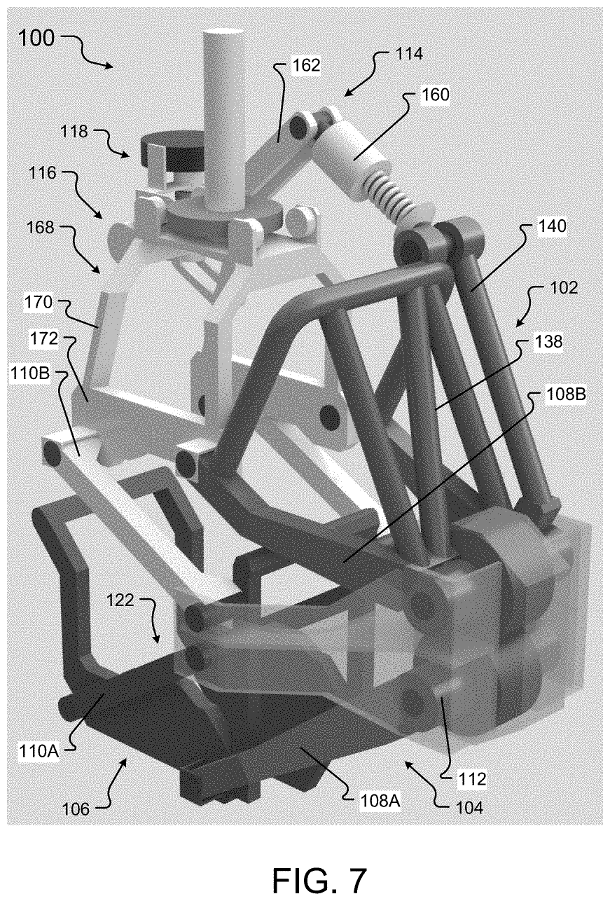

Referring now to FIGS. 7-10, the inter-relationships between the OGLA 108, the GSBC 114, and the PAWS 116 are illustrated. It is noted that the GSBC 114 may be considered a linkage assembly, for purposes of the present disclosure.

As illustrated in at least FIG. 7, the GSBC 114 includes a spring damper 160. In some embodiments, the spring damper 160 is coupled to at least one of the support frame 138 and the pivot frame 140. As the arms 132 of the OGLA 108B are connected to the spring damper 160 via at least one of the support frame 138 and the pivot frame 140, the force of the spring damper 160 being moved towards and away from the CLGB 112 is distributed to the arms 132 and ensures that the arms 132 move together. This also reduces torsion in the upper axle 154, as both the ends of the upper axle 154 rotate with the arms 132. In some embodiments, the spring damper 160 is pivotally connected to the support frame 138 and/or the pivot frame 140. In these embodiments, the spring damper 160 pivots about an axis that is parallel to the axles 152, 154 of the CLGB 112. In some embodiments, the spring damper 160 is fixedly attached to the support frame 138 and/or the pivot frame 140.

In additional embodiments, the spring damper 160 is pivotally connected to a linkage or arm 162 (e.g., a bell crank arm, or the like) of the CSBC 114 such that the raising and lowering of the PAWS 116 relative to the WCA 104 causes the spring damper 160 to expand and contract. In some embodiments, there is no spring damper 160, but only a strut damper. In these embodiments, there can be an energy recovery unit attached to the strut damper such that energy is recovered from the movement of the strut damper. In addition, the energy can be used by a lift motor or the drive motor 128 to drive the vehicle. The spring damper 160 and/or the strut damper is configured to cushion the motion of the PAWS 116 and WCA 104.

The GSBC 114 includes a gear assembly 164 and a lift motor 166 mounted atop the PAWS 116. In some embodiments, the gear assembly 164 is a worm gear assembly. The gear assembly 164 and the lift motor 166 actuates the linkage 162, altering compression in the spring damper 160. The GSBC 114 thus alters the spring pickup point, enabling a spring with greater than 8 inches (greater than 20 cm) of compression to operate across greater than 36 inches (greater than 90 cm) of wheel travel. In some embodiments, the spring damper 160 can be actuated by means other than the lift motor 166. For example, in alternative embodiments, a hydraulic ram can be attached to the spring damper 160 such that it pushes the spring damper 160 towards the CLGB 112. In some embodiments, a linear actuator can be used to move the spring damper 160. The linear actuator can be geared, electric, or electromagnetic. Other means that allow for controlled movement of the spring damper 160 can also be used, without departing from the scope of the present disclosure.

It is noted the LoTALS subsystem 102 may include one or more of the following subsystems: the WCA 104, the OGLA 108, the ILA 110, the CLGB 112, and/or the CSBC 114. The LoTALS subsystem 102 sets chassis roll and pitch angles based on commands from the DANCI (described in detail herein), where the commands are determined based on information received from a sensor array, and provides drive via the PADS 106 assemblies on the WCA 104.

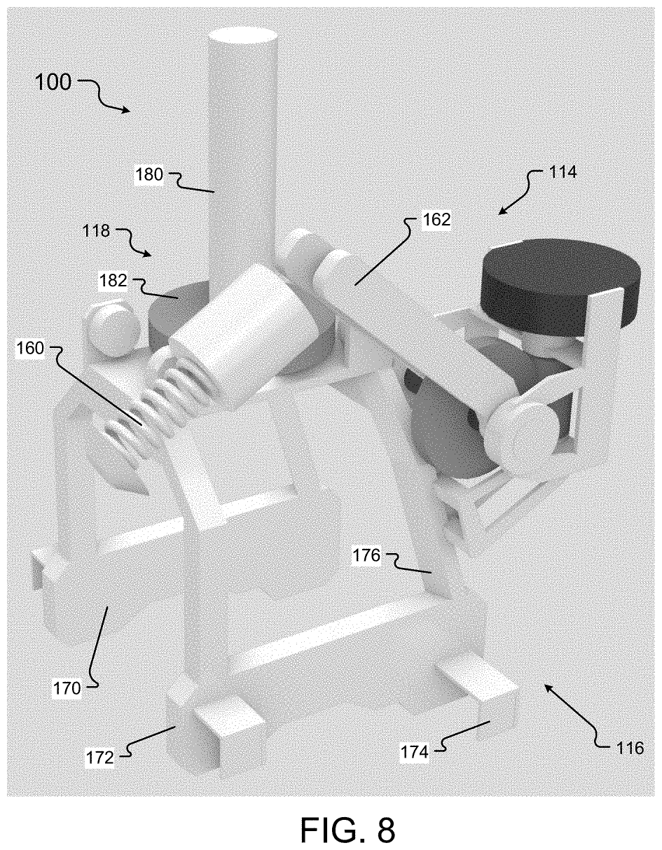

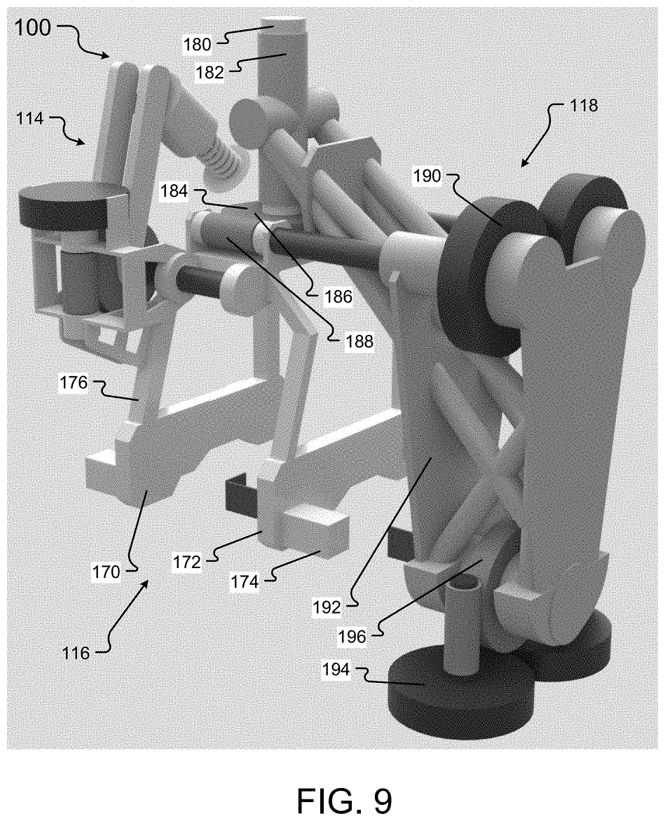

As illustrated in at least FIGS. 8-9, the PAWS 116 includes a fork assembly 168 that is operable to connect the WCA 104 to a chassis of a vehicle, as described in detail further herein. The fork assembly 168 includes a saddle 170 with lateral sidewalls 172. As shown, the sidewalls 172 include at least two apertures in each sidewall 172 to provide connection points for the arms 134, 136 of the, and the ends of the upper arms 134, 136 are pivotally connected to the apertures in sidewalls 172 of the saddle 170. Similarly, the ends of the lower arms 130, 132 are pivotally connected to the lower sidewalls 126 of the WCA 104. The connection of the gears 144, 146 of the axles 148, 150 respectively produces opposite rotation in the upper and lower axles. This opposite rotation causes the upper arms 134, 136 and the lower arms 130, 132 to pivot in opposite directions. Thus, the fork assembly 168 and the WCA 104 extend away from and towards each other based on the rotation of the axles 148, 150. In some embodiments, the fork assembly 168 and the WCA 104 can extend away from one another such that a gap of approximately 36 inches is formed. When the linkage 162 pivots towards the CLGB 112, the upper arms 134, 136 also toward the CLGB 112. This causes a rotation of the upper axle 150 within the CLGB 112, which causes opposite rotation of the lower axle 148 within the CLGB 112. The lower axle 148 thereby pivots the lower arms 130, 132 to extend away from the upper arms 134, 136 when the linkage 162 moves towards the CLGB 112.

In some embodiments, the upper arms 134, 136 are attached to the inside of the sidewalls 172 of the fork assembly 168. In alternative embodiments, the upper arms 134, 136 are attached to the outside of the sidewalls 172 of the fork assembly 168. In some embodiments, the front and rear upper arms 134, 136 may be connected to opposite sides of the sidewalls 172 of the fork assembly 168. Similarly, in some embodiments the lower arms 130, 132 are connected to the inside of the sidewalls 126 of the wheel carriage 122 and in some embodiments the lower arms 130, 132 are connected to the outside of the sidewalls 126 of the wheel carriage 122. In some embodiments, the front and rear lower arms 130, 132 are connected to opposite sides of the sidewalls 126 of the wheel carriage 122. It is noted that the pivoting joints between the upper arms 134, 136 and the fork assembly 168, and/or the pivoting joints between the lower arms 130, 132 and the wheel carriage 122, may be at least partially enclosed or protected by brackets or other shielding components 178.

In some embodiments, one or more of the arms 130, 132, 134, 136 includes a bushing, bearing, or other low friction element to allow for low friction rotation of the arms 130, 132, 134, 136 with respect to both the CLGB 112 and the wheel carriage 122 and/or the fork assembly 168. The arms 130, 132, 134, 136 can be connected by an axle, pin, or similar component that allows rotation within the bushing or bearing while securing the arms 130, 132, 134 ,136 to their respective pivot points on the CLGB 112 and the wheel carriage 122 and/or the fork assembly 168.

The fork assembly 168 includes one or more cross-members 176 that form structural arches. The cross-members 176 may include a plurality of straight and/or bent rails or other structural members that form an arch and couple the sidewalls 172 of the saddle 170 together. For example, the arch may be formed over the middle of the fork assembly 168. The front and rear cross-members 176 are connected by a crossbar or upper platform 178 at an opposite end to where the cross-members 176 connect the sidewalls 172.

In some embodiments, the fork assembly 168 is wider than the WCA 104. For example, the sidewalls 172 of the fork assembly 168 can be positioned on the outside of the sidewalls 126 of the wheel carriage 122, such that the wheel carriage 122 is between the sidewalls 172 of the fork assembly 168.

The PAWS 116 includes a steer tube 180 that extends vertically from an upper portion of the fork assembly 168. For example, the steer tube 180 may extends upwards from either the cross- members 176 and/or the crossbar or upper platform 178. The lift motor 166 mounted on one end of the fork assembly 168 is configured to drive the gear assembly 164, which engages linkage 162. The linkage 162 extends away from the fork assembly 168, and may be pivotally attached to the spring damper 160. The fork assembly 168 components are operable to lift the fork assembly 168 with respect to the rest of the components of the suspension system 100. In one non-limiting example, the lift motor 166 is operable to drive a worm gear of the gear assembly 164, which is mechanically connected to the linkage 162. When the worm gear rotates, the linkage 162 and the spring damper 160 move towards the CLGB 112.

In addition, the ASTRAL subsystem of the PAWS 116 boosts springing when the suspension system 100 linkages experience reduced mechanical leverage at either full suspension compression or droop. For example, at full compression, the fork assembly 168 of the PAWS 116 may deploy a pneumatic cylinder spring return device to assist the main-spring of the GSBC 114. In addition, rubber bump stops affecting the sector gears inside the CLGB 112 boost spring rates and limit travel at full droop.

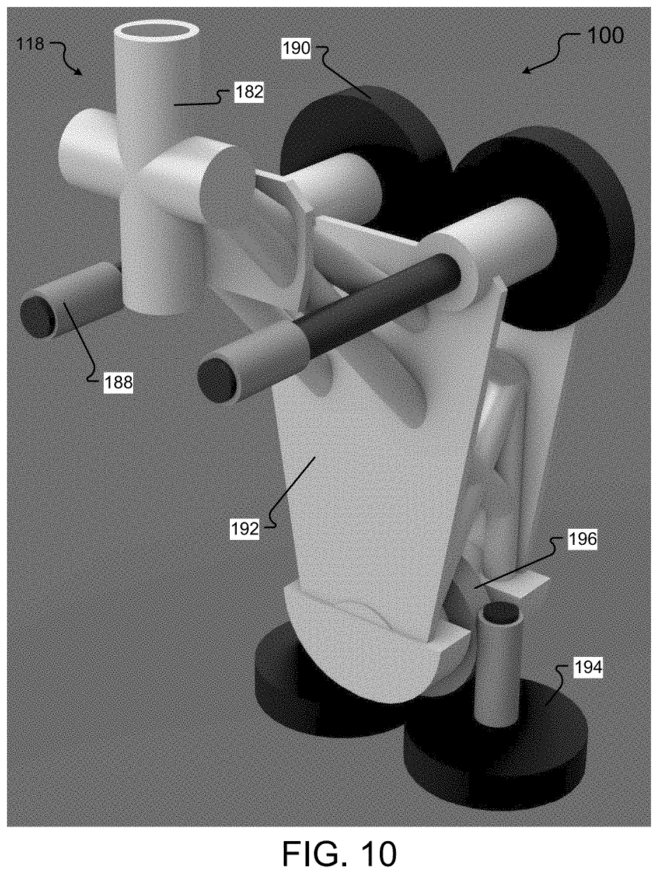

Referring now to FIGS. 9-10, the PACS 118 includes a head tube 182 that attaches pivotally to the steer tube 180 of the PAWS 116 via bearings (not shown) positioned at the steer tube 180. The fork assembly 168 provides steering via steering gear assembly 184. For example, the steering gear assembly 184 includes a worm wheel 186 near the base of the steer tube 180 engaged by two worm gears 188 driven by steering motors 190 that are mounted on a subframe 192 of the PACS 118.

The PACS 118 alters caster angles the wheel 120 depending on variables including, but not limited to, chassis pitch/roll angle, vehicle velocity, and terrain gradient. One or more computers (described in detail further herein), linked to an array of position sensors and an inertial measurement unit (IMU), calculates ideal caster angles using a pair of caster motors 194 turning a caster gear assembly 196 (e.g., including worm gears, and the like) enabling+−25° of caster change (50° total range) with relation to the chassis. Similar to but different from a motorcycle, the PACS 118 maintains proper positive trail steering on a chassis capable of pitching at 22°.

In some embodiments, the suspension systems 100 are connected to the chassis of the vehicle by a suspension sub-frame and a tie rod. The tie rod connects to the fork assembly 168 and the subframe is attached to the head tube 182. In some embodiments, the tie rod is attached behind the head tube 182. In some embodiments, the tie rod connects to the fork assembly 168 in front of the head tube 182. As the fork assembly 168 is connected to the sub-frame of the suspension and is not variable with respect to the vehicle, the tie rod is only required to move horizontally to adjust the wheel direction. In some embodiments, the tie rod does not require additional components to compensate for the wheel height changing due to terrain. The tie rod is positioned in a low friction bearing and thus steering the vehicle including the suspension systems 100 requires less force compared to other modern steering systems. In some embodiments, power steering is not needed and may not be present.

In some embodiments, the suspension sub-frame includes a chassis having a pivotable frame member attached to the front and rear ends of the vehicle. The frame member is pivotable about an axis extending across the width of the vehicle such that the sub-frame pivots towards the front end and the rear end of the vehicle. A linear actuator is attached to each frame member and controls the amount of rotation of the frame member with respect to the vehicle. In some embodiments, the frame member is pivotable between positive 30 degrees and negative 30 degrees with respect to a vertical axis. The sub-frame is attached to the proximal side of the suspension assembly with respect to the vehicle. More specifically, the suspension sub-frame is attached to the head tube 182. Thus, by extending or retracting the linear actuator, the wheel 120 is moved forwards and backwards with respect to the vehicle such that the caster angle is changed.

In some embodiments, the frame member is comprised of the axle on the chassis with each side of the frame member having an arcuate outer member that arcs outwards and ends in a vertical extension. A cross support can connect the vertical extension of each arcuate outer member to the bottom end of the opposite arcuate outer member. In some embodiments, a cross bar also connects the upper end of the cross support to provide additional structural support.

In some embodiments, the at least one linear actuator is pivotally mounted on the chassis and the extendable arm of the actuator is pivotally connected to the frame member. This allows the linear actuator to extend and retract while adjusting for the vertical position of the connection point on the frame member as it rotates about the pivot axis. In some embodiments, there are multiple linear actuators for a frame member. The linear actuators may be positioned in front of the front frame member and behind the rear frame member. Alternatively, in some embodiments the linear actuator may be located centrally towards the center of the chassis. Alternatively still, the linear actuator may be positioned below a pivot point of the subframe, inside the frame and below the floor in the nose and/or the tail of the vehicle. It is noted this alternative configuration may require suspension subframes with arms extending below the pivot point they alter caster around. In addition, it is noted this alternative configuration may result in more efficient packaging of components of the suspension system, which may free up room in the front and/or the back of the vehicle while lowering the center of gravity of the vehicle. In these embodiments, there can be one linear actuator having two extendible arms, each connecting to the subframe.

It is noted the linear actuators may be supplemented by or replaced by any known gear, power transmission belt, or chain drive known in the art. In one non-limiting example, the linear actuators may be supplemented with or replaced by a primary ring or spur gear on the axle of the subframe. Caster angle may be adjusted by turning a secondary spur gear with an electric motor, where the secondary spur gear meshes with the primary ring or spur gear. In another non-limiting example, the linear actuators may be supplemented with or replaced by a worm-gear and worm-wheel assembly. It is noted this may result in more efficient packaging of components of the suspension system.

It is contemplated that any of the subsystems of the suspension systems 100 may include local cooling units (e.g., oil, air, water, or the like), that are separate from other suspension systems 100 and/or separate from the chassis 200, without departing from the scope of the present disclosure. In addition, it is noted that the subsystems of the suspension systems 100 may share cooling components. In addition, it is contemplated that any subsystem and/or components within the subsystem may be sealed to prevent the ingress of water, dirt, or the like, without departing from the scope of the present disclosure.

In some embodiments, the suspension system 100 is present on one or more wheels of a vehicle 200. FIGS. 11-12 illustrate a vehicle 200, in accordance with one or more embodiments of the present disclosure. It is noted that the one or more components of the vehicle 200 may be considered part of a polymetric auto-leveling systems (PALS) configured to operate with a robotic transportation platform (RTP), or a PALS-RTP system 200.

In some embodiments, the vehicle 200 includes a chassis 202, four suspension systems 100 grouped into two M-PEDS units 204. It is noted that the suspension systems 100 may be considered sub-chassis systems or units 100, and/or the chassis 202 may be considered a main chassis 202, for purposes of the present disclosure. In some aspects, the suspension systems 100 and the M-PEDS units 204 may be configured in one or multiple track-widths, wheelbases, and/or ride heights. In one non-limiting example, the track widths may include, but are not limited to, 47.2 inches (120 cm) and 66.9 inches (170 cm) when at a 38-degree roll across two wheelbases including, but not limited to, 102 inches (260 cm) and 130 inches (330 cm). In another non-limiting example, the wheelbase may stretch from a nominal wheelbase of 102 inches to between 65.3 inches (166 cm) and 132.3 inches (336 cm) when the PACS 118 caster settings are that the maximum±25 degrees. It is noted that the variable track width and/or wheelbase renders Ackermann steering geometries impractical for the suspension systems 100.

In embodiments, each wheel 120 has an individually adjustable caster angle. In some embodiments, each wheel 120 has a specific linear actuator to adjust the caster angle of the wheel 120 independently of other wheels 120. In these embodiments, each suspension system 100 can be attached to its own axle, or other similar rotatable member, on the chassis, such that it is pivotable with respect to the chassis 202. For example, the PACS subframe 192 pivots axially at a lower end proximate to the chassis 202. For instance, the pivot point is near an axle line with the suspension systems 100 are configured to a nominal ride-height. The caster gear assembly 196 including a worm wheel attached to the lower end of the subframe 192 engages a worm gear driven by the caster motor 194, where the caster motor 194 is mounted in or proximate to the floor of the chassis 202. The caster gear assembly 196 pivots the subframe 192 such that it alters the caster angle of the wheel 120 (e.g., via altering of the fork assembly 168 via engagement of the steer tube 180 of the fork assembly 168 with the head tube 182 coupled to the subframe 192). It is contemplated that utilizing the PACS 118 to adjust caster angle may not allow for a static caster angle (e.g., a positive 5 degrees, as observed on many known vehicles).

In some embodiments, a pivotable arm or other adjustable means can be used to connect the suspension system 100 to the chassis 202. In some embodiments, each suspension system 100 is connected to an individual sub-frame member of the chassis. The sub-frame member is attached to the chassis by its own axle or other pivotable member and attaches to the wheel carriage assembly at the opposite end of the sub-frame. In some embodiments, the sub-frame is comprised of a bent outer member with a cross support that attaches to a support member of the sub-frame to increase the structural integrity of the sub-frame. In some embodiments, the sub-frame attaches to the head tube of the wheel assembly. An individual linear actuator is attached to the chassis and each sub-frame member.

In some embodiments, each wheel 120 is independently steerable with respect to the other wheels 120 of the vehicle 200. In these embodiments, each wheel 120 has a steering gear box that adjusts the steering angle of the vehicle with respect to the vehicle. a steering gearbox is positioned on the subframe and includes an individual steering motor to control the wheel angle. The steering arm and tie rod are connected to the head tube of the wheel assembly located on the fork assembly. The steering motor is then able to rotate the wheel assembly by moving the tie rod with respect to the wheel assembly.

In some embodiments, a steering wheel or yoke (not shown) of the vehicle 200 is connected digitally to the steering gear box and other steering systems. In some embodiments, a linear actuator is mounted to the vehicle. The extendable arm of the linear actuator is attached to a portion of the fork assembly such that the linear actuator can adjust the steer angle of the wheel assembly about the head tube by extending and retracting. In some embodiments, the linear actuator is connected to the fork assembly at a location in front of the head tube. In some embodiments, the linear actuator is connected behind the head tube. Additional steering mechanisms can include a steering motor that rotates the wheel assembly about the steer axis of the head tube via a steering gearbox.

In some embodiments, there are two pairs of tie rods, one pair for the front wheels and one pair for the rear wheels. This allows the vehicle to steer with all four wheels rather than only using the front wheels of the vehicle to steer as traditional vehicles do. Steering with all four wheels allows the vehicle to achieve the same turn radius with smaller steering angle. By actively steering with all four wheels, the required depth of the wheel wells is reduced. Additionally, as the same amount of turn is achieved with less horizontal movement of the tie rod, the force required to turn the tire is reduced. By tracking the front and rear wheels on the same arc the suspension system maximizes mid-corner regenerative braking potential because the wheels can be braked proportionally front and rear side to side without causing changes in the vehicle's vector at that moment.

In this regard, the vehicle 200 including the multiple suspension systems 100 allows the vehicle's weight to be shifted such that all suspension systems 100 experience approximately equal weight. For example, if the vehicle is turning to the right, the weight of the vehicle naturally shifts to the outside of the turn, or the left side, of the vehicle. In response to this, the left suspension systems 100 raises the respective fork assemblies 168, and the right suspension systems 100 lowers them, such that more weight is placed on the right wheels. This allows the inside wheels to provide more traction and angular acceleration about a turn, which increases the maximum turning speed and more resistance to sliding. In some embodiments, the vehicle is capable of executing turns at an approximately 45 degree incline.

In embodiments, the vehicle 200 includes battery packs 206. The battery packs 206 may be integrated into the chassis 202, or may be swappable from the chassis 202. In one example, the adjustable ride-height afforded by the suspension systems 100 enables hot-swappable modular battery packs, where the driver or a crew can opt to carry 1-5 modules, altering weight, performance, efficiency, and total range. The adjustable ride-height also enables hot swapping of batteries at recharge stations or in homes. It is noted that inductive charging and swappable battery packs may reduce range anxiety in electric vehicles, increase vehicle efficiency, and aid performance. For example, lower the chassis 202 lower to an inductive charging pad during charging to reduce the distance between the charging pad and the onboard components may reduce total charge time required. In addition, it is completed that battery modules can act as home battery backups, providing a more distributed power grid.

In embodiments, the vehicle 200 includes one or more computers or controllers 208 and sensors 210. It is noted the positioning of the controllers 208 and/or sensors 210 within FIGS. 10 and 11 is merely illustrative, and should not be interpreted as limited to the present disclosure.

In some embodiments, the controllers 208 are provided in communication with the linear actuator, the motor 166, and the drive motor 128 of the various suspension systems 100 of the vehicle 200. The controllers 208 thereby adjust the speed of the wheels 120 based on input from an operator or other criteria, the lift motor 166 based on the driving conditions and terrain, and the caster angle based on the amount of acceleration or deceleration along with other conditions. The controllers 208 can be programmed to operate each wheel 120 individually (e.g., where the controllers 208 are local to a specific suspension system 100), may be programmed to communicate with other controllers 208 of other suspension assemblies 100, and/or may be a global controller for to control all suspension systems 100. Thus, each suspension system 100 can be individually controlled to compensate for terrain, vehicle acceleration or deceleration, and radial acceleration to provide a smooth ride for the vehicle occupants.

In embodiments, the sensors 210 are provided at various locations on the vehicle 200. The controller 208 use readings from the sensors 210 to calculate the desired angle for the caster and the arms 130, 132, 134, 136. The controllers 208 use an algorithm to calculate the desired angles. In some embodiments, aspects of the DANCI and/or ASTRAL subsystems may be integrated within the controller 208 and/or include components in communication with the controller 208 (e.g., the sensors 210, a yoke, user interfaces, and the like).

It is noted that the suspension systems 100 may be coupled to the vehicle 200 via a minimal number of mechanical connectors (e.g., at the chassis 202), fluid connectors such as hydraulic and/or pneumatic connectors (e.g., to provide coolant or other fluids between the chassis 202 and the suspension systems 100), and/or electrical connectors (e.g., to provide power and/or data transfer between the chassis 202 and the suspension systems 100). Minimizing these connectors allows for the swapping of entire suspension systems 100 from the vehicle 200, instead of swapping individual components within the suspension system 100. This allows for a faster, more efficient repair process for the vehicle 200. In some non-limiting examples, the suspension systems 100 may each be coupled to the chassis 202 via one or more main bolts (e.g., six main bolts). For instance, two bolts may be inserted from a bottom surface, two bolts may be inserted from a top surface, and two bolts may be inserted on either side of the suspension system 100 to couple the suspension system 100 to the chassis 202.

The controllers 208 may include one or more control units of a general control system. The one or more control units may include processor and memory (e.g., a memory medium, memory device, or the like). The processors may be configured to execute program instructions maintained on or stored in the memory. It is noted the processors of the one or more control units may execute any of the various method or process steps necessary to operate the suspension systems 100 and/or components on the vehicle 200 in general.

The control system may include a user interface coupled (e.g., physically coupled, electrically coupled, communicatively coupled, or the like) to the one or more control units. For example, the user interface may be a separate device coupled to the one or more control units. By way of another example, the user interface and the one or more control units may be located within a common or shared housing. The user interface may include one or more displays and/or one or more user input devices.

The control system may include one or more sensors coupled (e.g., physically coupled, electrically coupled, communicatively coupled, or the like) to the one or more control units and to components of the suspension system (e.g., motors, actuators, energy recovery units, yokes, or the like as described throughout the present disclosure). The control system may include one or more receivers configured to receive data from the suspension system (e.g., from sensors installed within the suspension system) or from external third-party control units (e.g., controllers, servers, or the like) either via wired connections or wireless connections.

The control system may be configured to monitor the suspension system via received and/or transmitted data. The control system may be configured to generate control signals to adjust one or more components of the suspension system via a feedback loop or a feed forward loop based on the received and/or transmitted data. The control system may be configured to receive and/or transmit data in a standardized format and/or a non-standardized format. Where the data is in a non-standardized format, the data may be converted to a standardized format upon receipt and/or prior to transmission to sensors, third-party control units, or the like.

The general control system may include the computer of a vehicle and/or may be in communication with the computer of a vehicle. Where the vehicle is an automobile or other driveable vehicle, the computer may include, but is not limited to, a Powertrain Control Module (PCM), Engine Control Module (ECM)/Engine Control unit (ECU), Transmission Control Module (TCM), or the like.

It is noted the suspension systems 100 may be configured to actively adjust camber and/or toe, in addition to or instead of adjusting caster and/or ride height, without departing from the scope of the present disclosure. As used herein, camber is the angle of a wheel relative to the vertical of a vehicle, with positive camber pointed away from vertical/from vehicle at the top of the wheel and negative camber pointed toward vertical/toward vehicle at the top of the wheel. As used herein, toe is a measurement determining how much a wheel is turned in or out from a straight-ahead position by comparing track widths at leading and trailing edges of the tires, with toe in meaning side-adjacent wheels are closer in the front and toe out meaning side-adjacent wheels are closer at the rear. Active adjustment of wheel camber and/or toe may balance changes in handling or turning, accelerating, braking, ride stability, and off-road ability, thus optimizing vehicle stability and reducing steering effort and wasted energy spent turning the wheels. Therefore, the above description should not be interpreted as limiting on the scope of the present disclosure but merely an illustration.

In addition, it is noted the suspension systems 100 may be configured to actively adjust roll center by adjusting an angle of various components in the suspension system. As used herein, the term “roll center” references to a point about which a chassis rolls, and is dependent on a distance from a center of gravity (CG) of the suspension system. In some instances, lowering the roll center may require flattening or reducing an angle of select components of the suspension system relative to a ground surface, while increasing the roll center may require sharpening or increasing the angle of the select components of the suspension system relative to the ground surface.

Where the wheel 120 is installed at a steering end of the vehicle 200, adjusting the corresponding suspension systems 100 to a lower roll center (e.g., further from the CG) results in less roll in a corner and additional grip at the steering end of the vehicle and more on-throttle steering, but less overall responsiveness. In addition, adjusting the corresponding suspension systems 200 to a higher roll center (e.g., closer to the CG) results in less on-throttle steering and more responsiveness.

Where the wheel 120 is installed at a non-steering end of the vehicle 200, adjusting the corresponding suspension systems 200 to a lower roll center (e.g., further from the CG) results in more on-throttle grip, less grip under braking, increased traction, but overall less responsiveness. In addition, adjusting the corresponding suspension systems 200 to a higher roll center (e.g., closer to the CG) results in less on-throttle steering and more responsiveness.

In some embodiments, the vehicle 200 deploys a Linux OS central computer or controller 208 to calculate wheel speed, caster angle, steering angle, and chassis ride-height (thereby controlling camber) at each wheel 120 on the order of milliseconds. An IMU acts as the primary sensor among an array of at least 16 position sensors (depending on redundancy) feeding the computer information from numerous components. The controller 208 calculates refreshed settings for several subsystems after interpreting DANCI inputs against the sensor array and code algorithms. Position sensors return steering, caster, lift-arm angle (ride-height), and linkage or bell crank angles to the controller 208, which calculates spring compression and rebound rates whereby the motors may be backdriven to harvest energy from bumps and dips in the terrain, partly recapturing energy lost to hydraulic dampers.

The DANCI system sends driver inputs to the computer for calculating steering and caster angles, motor torque application, and ride-height at each wheel. In some instances, the DANCI system implements a digital flight-simulator yoke incorporating motorcycle-style brake levers instead of or in addition to foot pedals, such that the vehicle 200 may be operable by paraplegics can drive with few modifications. For example, the driver may pull the yoke to accelerate, push to decelerate, and turn the yoke like any normal steering wheel.

In embodiments, position sensors inform the controller 208 of steering and caster angles, wheel locations, and spring compressions at a particular time. After determining the rate of spring compression, ride-height, steering angle, caster angle, wheel-speed based on the provided information, the computer will compare results against that of an ideal model to rapidly calculate new inputs for each subsystem. In some embodiments, the controllers 208 account for track-width and wheelbase-length changes while the vehicle rolls and pitches into the corner, setting steering angles that maintain ideal positive trail steering kinematics. The caster-angle motors will set independent angles based upon such variables as vehicle speed, terrain gradient, and pitch/roll angle before calculating a new angle that helps maintain optimum stability. The traction motors will reduce power to any wheel speeds off plan from a codebase that accounts for numerous variables and inputs. In some embodiments, the sensors 210 additionally or alternatively include sixteen position sensors and twenty-four motor speed controllers, an IMU, infrared cameras, radar, ultrasonic, and LiDAR sensors. For example, the controllers 208 may obtain information from an IMU prior to altering chassis pitch and roll to control the vehicle 200.

In some embodiments, the controllers 208 may estimate models to build initial concepts and/or capture real-world readings from the sensors 210 to identity variations between theoretical and actual performance. In some embodiments, the controllers 208 take into account one or more of surface undulations, varying temperature, and weather conditions while proportionally distributing drive torque and monitoring for tire-slip, which may involve determinations made based on real-world data captured by the sensors 210. In some embodiments, the controller 208 may separately store vehicle operation data (e.g., steering angle, ride-height, speed, lateral G-force, and the like from environment or other external data (e.g., time, location, operator, tire size, and the like).

In an effort to improve cornering, the PALS-RTP system takes into considerations operational parameters including, but not limited to, vertical loading, lateral and/or longitudinal weight transfer, steering angle, caster and/or camber angles, and motor drive torque. Based on these considerations, the controller 208 adjusts one or more components of the vehicle 200 and its suspension systems 100 as necessary.

For example, the PALS-RTP system is configured to equally loads all wheels 120 at all times, shifting mass away from inertial surge and sway forces while applying heave forces vertically across all wheels 120, by adjusting aspects of the various suspension systems 100. Thus, the PALS-RTP system requires equal work from all wheels 120, enhancing efficiency, mechanical grip, and dynamic performance.

By way of another example, the PALS-RTP system enhances mechanical grip by shifting mass away from inertial forces, thereby preventing lateral and/or longitudinal weight transfer and resultant loss of mechanical grip (e.g., that a user may see in legacy automotive suspension systems that typically require the front/back/outside tires to bear over 70 percent of the braking/accelerating/cornering duties. In particular, the GSBC 114 provides the PALS-RTP system with variable roll-resistance, allowing increased or decreased spring loads at each wheel 120 enabling a stable roll-center always at the track centerline. The PALS-RTP shifts chassis mass to counteract inertial weight transfer, thereby extracting more of the available mechanical grip. By preventing weight transfer and proportionally dividing vertical loads across all tires, the PALS-RTP system increases grip yielding improved safety, stability and emergency handling. The PALS-RTP system also enhances dynamic performance by distributing torque intelligently and shifting chassis vehicle mass proportionally across all tires when braking, cornering, or accelerating. It is noted the PALS-RTP system may shift greater than 80% of the vehicle mass inside of the centerline of the track when at full-lean, reducing the propensity for roll-over. In addition, it is noted the PALS-RTP system may prevents spin-outs by equally loading tires and strictly controlling motor torque at each wheel, with the controller 208 setting expected wheel speeds individually and reducing torque to any wheel with speed values exceeding those calculated.

By way of another example, the PAWS 116 operates purely on a horizontal plane and uses no tie-rods at all. Instead, a set of redundant worm-gears engages a worm-wheel at the bottom of the steer tube. PALS-RTP steers the wheel 120 on a linear plane, completely isolating steering and suspension systems and removing any propensity for bump steer (e.g., that one may see with solid beam axles or double-wishbone suspensions). The PALS-RTP system also sets steering angles that account for a variable track and/or wheelbase.

By way of another example, the PALS-RTP features a very low center of gravity often below the axle line (when at nominal or lower ride-heights), combined with an instantaneous center located at infinity and roll center that never moves from track centerline at ground level. The GSBC 114 acts as a variable rate roll-bar, whereby it can apply spring forces that counteract the roll or pitch motions. The static nature of the roll-center and instantaneous center provide for consistent roll forces which in turn should make for simpler suspension tuning

By way of another example, steering angles calculated by the controller 208 must account for track-width variation and/or wheelbase variation when setting steering angles, including taking into consideration factors such as positive trail steering, chassis pitch/roll angle, terrain gradient, and caster angle. In addition, the controller 208 may need to take into account unconventional steering maneuvers including lateral mobility (useful for parallel parking maneuvers), “tank-turns” and “crab walks”, and even true crawling and walking maneuvers. It is noted that the active caster system and active ride height can move the vehicle without any drive sent to the wheels 120.

By way of another example, the PALS-RTP system generates virtual differentials between the suspension systems 100 in the M-PEDS units 204. This provides the PALS-RTP system the benefits of both a fully locked and unlocked differential at any time, while allowing for the identification of wheel-spin by detecting variations in wheel RPM versus those set by the controller 208, to control spin-outs by cutting power to any wheel experiencing loss of grip.

By way of another example, the PALS-RTP system (e.g., through the PACS 118) must set and maintain caster angles that enable optimal vehicle control despite chassis pitch angles up to 22°. The PACS 118 is configured to set caster angles promoting positive trail between the tire contact patch and the steering head angle. Caster angles must account for chassis pitch and roll, vehicle speed and terrain gradient, along with the migration of the tire contact patch that accompanies roll on toroidal tires. As the chassis rolls, lateral migration of the contact patch and the development of camber thrust will exceed that of other 4 wheeled vehicles. At high angles of chassis roll, depending on vehicle speed and terrain gradient, small steering angles will result in large changes to slip angle and trail. Thus, calculating ideal steering and caster angles based on terrain gradient will need to factor camber thrust and force balance equations when calculating ideal steering and caster angle settings.

By way of another example, the PALS-RTP system allows for longer braking through a corner. In cases where regenerative braking technologies are applied to the vehicle 200, the PALS-RTP system may proportional braking during stopping events, enabling greater potential for regenerative braking by engaging the rear wheels more. In addition, the PALS-RTP system may calculate spring compression rates by measuring position sensors at the GSBC 114 against those of other components . From spring compression rates, expected rebound rates may be calculated whereby the PALS-RTP system can harvest power from the suspension motion induced by surface undulation.

By way of another example, the PALS-RTP system allows for improved ground clearance, approach, departure, and/or breakover angles. With over 36 inches of wheel travel and the ability to vary default ride-heights the PALS-RTP system offers ground clearance few other vehicles can offer. In addition, the nominal wheelbase of approximately 102 inches, combined with very high ground clearance create breakover angles greater than that of extreme off-roaders. The short overhangs push the wheels to the vehicle corners, offering approach and departure angles exceeding 80°. The short wheelbase, narrow track, and four-wheel steering capability allows for a very tight turning radii, with holonomic drive and independent steering angles enabling novel steering maneuvers, and each wheel 120 steering and driving independently of the other wheels. This enables “crab-walk” and “tank turn” maneuvers, and the like. The PALS-RTP system allows for a self-leveling chassis 202.

By way of another example, the vehicle 200 may move without use of the drive motors 128. For instance, each wheel 120 can set independent positive/negative caster angles of up to 25° (50° total range). When at full ride-height this can allow for wheelbase changes up to nearly 29.3%. By lifting one wheel at a time, moving that wheel from full negative caster to full positive caster allows the vehicle to “walk.” In addition, with sufficient force at the GSBC 114, the vehicle 200 may be made to “jump” a meter or more into the air in order to free itself from obstacles. The PALS-RTP system will self-level as it touches ground and to maintain full control of the vehicle after impact. Thus, the PALS-RTP system offers vehicles that will rarely get stranded.

By way of another example, the PALS-RTP vastly reduces the amount of motion transfer experienced by passengers and payload versus legacy suspension systems. This results in significantly improved rider comfort and payload integrity. In addition, the PALS-RTP system seeks to nearly eliminate surge and sway forces, leaving only heave to press passengers and payload into seats or compartments. This may assist in offers a solution to the phenomenon where fully autonomous vehicles will increase the propensity for motion sickness in passengers with reduced ability to anticipate vehicle movements, by significantly reducing the motion transfer. This may also assist in a reduction of shipping losses to broken freight by significant margins, creating efficiencies that percolate through several sectors of the economy.

By way of another example, the PALS-RTP system rolling and pitching the suspension systems 100 with variable ride-height enables optimal transfer of power from inductive charging. Efficient inductive charging depends upon maintenance of shallow clearances and perpendicular orientations between transmitting and receiving induction coils. For example, Qi near-field wireless calls for charging distances of less than 4 cm (1.6″) between coils. Thus, the PALS -RTP rolling/pitching and variable ride-height capability will allow for setting optimal clearances and orientations between inductive transmitter and receiver coils, significantly increasing inductive charging efficiency. The PALS-RTP system with optimized in-road inductive charging and modular battery swapping may thus reduce the need for large batteries and EV range anxiety.

It is noted that positioning the M-PEDS 204 in the front and rear of the chassis 202 increases the distance of many large mechanical systems in a vehicle away from occupants. The M-PEDS thus can provide inherent protection for occupants within the vehicle 200 from crashes, as the impact-absorbing subchassis structures at the front and rear the vehicle 200 are configured to reduce injuries. In addition, the chassis design has robust impact and safety features. Although not shown, additional shielding may be added to the suspension systems 100 to reduce damage to the actuatable portions of the suspension systems 100 and/or reduce possible injury to occupants within the vehicle 200.

Benefits of the PALS-RTP system over existing systems include reducing roll-over and spin-out accidents by monitoring distribution of power and/or adjusting the suspension systems 100 to counter any observed issues. In addition, the PALS-RTP system may reduce energy consumption, facilitating the transition to renewable energy. The PALS-RTP system may allow for lightweight vehicles with low-frontal area (low drag), low-friction drivelines, and low rolling resistance that may result in significantly increased vehicle efficiencies. In particular, the PALS-RTP system has no transmission, no central drive-shafts, no differentials, and no constant-velocity drive-shafts or CV joints adding to driveline drag that may results in frictional losses around 20%. It is contemplated that the PALS-RTP system may be suitable for off-road vehicles; networked commuter cars, trucks, and medium-duty freight vehicles; military and aerospace vehicles; wheelchairs and disabled access vehicles; networked public transportation pods; police, fire, and medical first-responder vehicles; delivery, warehouse, factory transport robots, and pods; personal mobility devices; search and rescue vehicles and robot probes; and the like.

Various features and embodiments of a vehicle suspension system with active adjustment of wheel caster angle and ride height have been provided herein. It will be recognized, however, that various features are not necessarily specific to certain embodiments and may be provided on any one or more embodiments. The present disclosure and embodiments provided herein are not mutually exclusive and may be combined, substituted, and omitted. The scope of the invention(s) provided herein is thus not limited to any particular embodiment, drawing, or particular arrangement of features.

It is to be understood that the disclosure is not limited to particular methods or systems, which can, of course, vary. It is also to be understood that the terminology used herein is for the purpose of describing particular embodiments only and is not intended to be limiting.

A number of embodiments of the disclosure have been described. Nevertheless, it will be understood that various modifications may be made without departing from the spirit and scope of the present disclosure. Accordingly, other embodiments are within the scope of the following claims.

While various embodiments of the system have been described in detail, it is apparent that modifications and alterations of those embodiments will occur to those skilled in the art. It is to be expressly understood that such modifications and alterations are within the scope and spirit of the present disclosure. In addition, the invention(s) described herein are capable of other embodiments and of being practiced or of being carried out in various ways. Further, it is to be understood that the phraseology and terminology used herein is for the purposes of description and should not be regarded as limiting. The use of “including,” “comprising,” or “having” and variations thereof herein are meant to encompass the items listed thereafter and equivalents thereof, as well as, additional items.

The following claims particularly point out certain combinations and subcombinations regarded as novel and nonobvious clipboards. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. A suspension system for a vehicle, the suspension system comprising:
a wheel carriage assembly including a wheel carriage and a wheel;
a steering subsystem including a fork assembly, the steering subsystem operable to rotate the wheel between a first steering direction and a second steering direction;
a caster subsystem coupled to the steering subsystem, the caster subsystem operable to rotate the fork assembly between a first caster angle and a second caster angle, wherein the caster subsystem is coupled to the steering subsystem;
a linkage assembly coupled to the steering subsystem, the linkage assembly operable to translate the wheel between a first wheel height and a second wheel height relative to the fork assembly of the steering subsystem; and
a gear box, wherein the steering subsystem, the caster subsystem, and the linkage assembly are coupled to the wheel carriage assembly via the gear box.

2. The suspension system of claim 1, further comprising:
at least one arm coupled to the gear box and the wheel carriage of the wheel carriage assembly; and
at least a second arm coupled to the gear box and the fork assembly of the steering subsystem, the at least a second arm including a pivot frame configured to couple to the linkage assembly,
wherein the translational motion between the first wheel height and the second wheel height is transferred between the linkage assembly and the wheel carriage assembly via the at least one arm and the at least a second arm.

3. The suspension system of claim 2, wherein the gear box comprises:
a first spur gear in communication with the at least one arm coupled to the gear box and the carriage frame of the wheel carriage assembly; and
a second spur gear in communication with the at least a second arm coupled to the gear box and the fork assembly of the steering subsystem,
wherein the first and second spur gears are intermeshed such rotation of the first spur gear in a first rotational direction causes the second spur gear to rotate in a second rotational direction to transfer the translational motion between the first wheel height and the second wheel height between the linkage assembly and the wheel carriage assembly.

4. The suspension system of claim 1, wherein the linkage assembly comprises:
a damper;
a linkage coupled to the damper; and
a lift motor and a worm gear assembly operable to actuate the linkage to compress or decompress the damper and cause the wheel to translate between the first wheel height and the second wheel height relative to the fork assembly of the steering subsystem, wherein the translation between the first wheel height and the second wheel height is transferred to the wheel via the gear box.

5. The suspension system of claim 4, wherein the damper is coupled to the gear box via at least one arm.

6. The suspension system of claim 1, wherein the wheel carriage assembly includes a motor operable to drive the wheel.

7. The suspension system of claim 1, wherein the steering subsystem comprises:
a head tube coupled to and operable to rotate about a steer tube of the fork assembly; and
a steering motor and worm gear assembly operable to rotate the steer tube of the fork assembly between the first steering direction and the second steering direction, wherein the rotation between the first steering direction and the second steering direction is transferred to the wheel via the gear box.

8. The suspension system of claim 7, wherein the caster subsystem comprises:
a subframe coupled to the head tube of the steering subsystem; and
a caster motor and worm gear assembly operable to rotate the subframe between the first caster angle and the second caster angle, wherein the rotation between the first caster angle and the second caster angle is transferred to the wheel via the steering subsystem and the gear box.

9. The suspension system of claim 1, wherein at least one motor of the suspension system is powered by a battery pack installed on the chassis of the vehicle.

10. A vehicle, comprising:
a chassis; and
a plurality of suspension systems, each suspension system of the plurality of suspension systems comprising:
a wheel carriage assembly including a wheel carriage and a wheel;
a steering subsystem including a fork assembly, the steering subsystem operable to rotate the wheel between a first steering direction and a second steering direction;
a caster subsystem coupled to the steering subsystem, the caster subsystem operable to rotate the fork assembly between a first caster angle and a second caster angle, wherein the caster subsystem is coupled to the steering subsystem;
a linkage assembly coupled to the steering subsystem, the linkage assembly operable to translate the wheel between a first wheel height and a second wheel height relative to the fork assembly of the steering subsystem; and
a gear box, wherein the steering subsystem, the caster subsystem, and the linkage assembly are coupled to the wheel carriage assembly via the gear box,
wherein at least one suspension system of the plurality of suspension systems are independently adjustable with respect to at least one of steering direction, wheel caster angle, and wheel height relative to the other suspension systems of the plurality of suspension systems.

11. The vehicle of claim 10, wherein a first wheel of a first suspension system of the plurality of suspension system is rotatable between a first steering direction and a second steering direction while the respective steering direction of other wheels of the other suspension systems of the plurality of suspension systems remains substantially constant.

12. The vehicle of claim 10, wherein a first wheel of a first suspension system of the plurality of suspension system is rotatable between a first caster angle and a second caster angle while the respective caster angle of other wheels of the other suspension systems of the plurality of suspension systems remains substantially constant.

13. The vehicle of claim 10, wherein a first wheel of a first suspension system of the plurality of suspension system is translatable between a first wheel height and a second wheel height while the respective wheel heights of other wheels of the other suspension systems of the plurality of suspension systems remains substantially constant.

14. The vehicle of claim 10, wherein at least one suspension system of the plurality of suspension systems is swappable on the chassis as a complete unit.

15. The vehicle of claim 10, further comprising:
at least one battery pack installed on the chassis of the vehicle and operable to power one or more motors of each of the plurality of suspension systems.

16. The vehicle of claim 15, wherein the at least one battery pack is swappable on the chassis.

17. The vehicle of claim 10, further comprising:
at least one sensor operable to collect data for at least one suspension system of the plurality of suspension systems; and
at least one controller operable to receive the data from the at least one sensor, the at least one controller operable to determine one or more adjustments to the at least one suspension system of the plurality of suspension systems based on the received data, the at least one controller further operable to transmit a control signal to at least one motor on the at least one suspension system of the plurality of suspension systems based on the determined adjustment,
wherein the control signal transmitted to at least one motor on the at least one suspension system of the plurality of suspension systems causes an adjustment in at least one of steering direction, caster angle, and ride height of the wheel of the at least one suspension system of the plurality of suspension systems.

18. A method for controlling a vehicle, comprising:
collecting data via at least one sensor on a suspension system, the suspension system comprising:
a wheel carriage assembly including a wheel carriage and a wheel;
a steering subsystem including a fork assembly, the steering subsystem operable to rotate the wheel between a first steering direction and a second steering direction;
a caster subsystem coupled to the steering subsystem, the caster subsystem operable to rotate the fork assembly between a first caster angle and a second caster angle, wherein the caster subsystem is coupled to the steering subsystem;
a linkage assembly coupled to the steering subsystem, the linkage assembly operable to translate the wheel between a first wheel height and a second wheel height relative to the fork assembly of the steering subsystem; and
a gear box, wherein the steering subsystem, the caster subsystem, and the linkage assembly are coupled to the wheel carriage assembly via the gear box;
receiving the data collected by the at least one sensor via at least one controller;
determining one or more adjustments to the suspension system based on the received data; and
transmitting a control signal to the suspension system based on the determined adjustment,
wherein the control signal transmitted to the suspension system causes an adjustment in at least one of steering direction, caster angle, and ride height of the wheel of the suspension system.

19. The method of claim 18, wherein the control signal is transmitted to at least one motor on the suspension system.

20. The method of claim 18, further comprising:
receiving an input from a user control;
determining one or more adjustments to the suspension system based on the received input; and
transmitting a control signal to the suspension system based on the determined adjustment,
wherein the control signal transmitted to the suspension system causes an adjustment in at least one of steering direction, caster angle, and ride height of the wheel of the suspension system.
